(19) United States
(12) Patent Application Publication
(10) Pub. No.: US 2017/0064335 A1
(43) Pub. Date: Mar. 2, 2017

(54) METHOD AND APPARATUS FOR IMAGE TRANSFORMATION, AND METHOD AND APPARATUS FOR IMAGE INVERSE-TRANSFORMATION BASED ON SCANNING SEQUENCE

(71) Applicants: SAMSUNG ELECTRONICS CO., LTD., Suwon-si (KR); Seoul National University R&DB Foundation, Seoul (KR)

(72) Inventors: Sang-kwon NA, Seoul (KR); Soo-ik CHAE, Seoul (KR); Ki-won YOO, Seoul (KR); Soon-woo CHOI, Seoul (KR); Wook-seok JEONG, Seoul (KR)

(73) Assignees: SAMSUNG ELECTRONICS CO., LTD., Suwon-si (KR); Seoul National University R&DB Foundation, Seoul (KR)

(21) Appl. No.: 15/184,300

(22) Filed: Jun. 16, 2016

(30) Foreign Application Priority Data
Aug. 31, 2015 (KR) 10-2015-0123204

(51) Int. Cl. H04N 19/61; H04N 19/129; H04N 19/126

(52) U.S. Cl. CPC H04N 19/61; H04N 19/126; H04N 19/129; H04N 19/176

(57) ABSTRACT

Provided is a method of encoding an image, the method including determining a scanning sequence for transforming one or more sub-blocks included in a transformation block to be identical to a sequence of quantizing the one or more sub-blocks; determining a sub-block for transformation from among the one or more sub-blocks according to the determined scanning sequence; and performing transformation by applying one or more transformation matrixes with respect to the sub-block for transformation.

### CROSS-REFERENCE TO RELATED APPLICATION

This application claims the benefit of Korean Patent Application No. 10-2015-0123204, filed on Aug. 31, 2015, in the Korean Intellectual Property Office, the disclosure of which is incorporated herein in its entirety by reference.

### BACKGROUND

1. Field

The present disclosure relates to methods and apparatuses for transforming and inverse-transforming an image by transforming a sub-block based on a scanning sequence.

2. Description of the Related Art

As hardware for reproducing and storing high resolution or high quality video content is developed and supplied, a need for a video codec for effectively encoding or decoding the high resolution or high quality video content is increasing. According to a video codec of the related art, a video is encoded according to a limited encoding method based on a coding unit having a certain size.

Image data of the spatial domain is transformed into coefficients of the frequency domain via frequency transformation. According to a video codec, an image is split into blocks having a certain size, discrete cosine transformation (DCT) is performed on each block, and frequency coefficients are encoded in block units, for rapid calculation of frequency transformation. Compared with image data of the space domain, coefficients of the frequency domain are easily compressed. In particular, since an image pixel value of the spatial domain is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

### SUMMARY

According to an aspect of an embodiment, a method of encoding an image, the method includes determining a scanning sequence for transforming one or more sub-blocks included in a transformation block to be identical to a sequence of quantizing the one or more sub-block; determining a sub-block for transformation from among the one or more sub-blocks according to the determined scanning sequence; and performing transformation by applying one or more transformation matrixes with respect to the sub-block for transformation.

The determined scanning sequence may be a reverse scanning sequence and includes a horizontal scanning sequence, a vertical scanning sequence, and an upright diagonal scanning sequence.

The one or more transformation matrixes may include a first transformation matrix and a second transformation matrix that is a transposed matrix of the first transformation matrix.

When the determined scanning sequence is the horizontal scanning sequence, the first transformation matrix may be applied with respect to the sub-block for transformation first, and, when the determined scanning sequence is the vertical scanning sequence or the upright diagonal scanning sequence, the second transformation matrix may be applied with respect to the sub-block for transformation first.

The performing of the transformation may include performing transformation by using a processing unit identical to processing units for quantization and rate-distortion cost calculation that are performed in the form of a pipeline after the transformation.

A size of each of the one or more sub-block is 4×4, and a size of the transformation block is equal to or greater than 4×4.

According to an aspect of an embodiment, a method of decoding an image, the method includes determining a scanning sequence for inverse-transforming one or more sub-blocks included in an inverse-transformation block to be identical to a sequence of inverse-quantizing the one or more sub-blocks; determining a sub-block for inverse-transformation from among the one or more sub-blocks according to the determined scanning sequence; and performing inverse-transformation by applying one or more inverse-transformation matrixes with respect to the sub-block for transformation.

The determined scanning sequence may be a reverse scanning sequence and includes a horizontal scanning sequence, a vertical scanning sequence, and an upright diagonal scanning sequence.

The one or more inverse-transformation matrixes may include a first inverse-transformation matrix and a second inverse-transformation matrix that is a transposed matrix of the first inverse-transformation matrix.

When the determined scanning sequence is the horizontal scanning sequence, the first inverse-transformation matrix may be applied with respect to the sub-block for inverse-transformation first, and, when the determined scanning sequence is the vertical scanning sequence or the upright diagonal scanning sequence, the second inverse-transformation matrix may be applied with respect to the sub-block for inverse-transformation first.

The performing of the inverse-transformation may include performing inverse-transformation by using a processing unit identical to a processing unit for quantization that is performed in the form of a pipeline before the inverse-transformation.

A size of each of the one or more sub-block may be 4×4, and a size of the inverse-transformation block may be equal to or greater than 4×4.

According to an aspect of an embodiment, an image encoding apparatus includes a transformation sequence determiner configured to determine a scanning sequence for transforming one or more sub-blocks included in a transformation block to be identical to a sequence of quantizing the one or more sub-blocks and determine a sub-block for transformation from among the one or more sub-blocks according to the determined scanning sequence; and a transforming unit configured to perform transformation by applying one or more transformation matrixes with respect to the sub-block for transformation.

According to an aspect of an embodiment, an image decoding apparatus includes an inverse transformation sequence determiner configured to determine a scanning sequence for inverse-transforming one or more sub-blocks included in an inverse-transformation block to be identical to a sequence of inverse-quantizing the one or more sub-blocks and determine a sub-block for inverse-transformation from among the one or more sub-blocks according to the determined scanning sequence; and an inverse transforming unit configured to perform inverse-transformation by applying one or more inverse-transformation matrixes with respect to the sub-block for transformation.

According to an aspect of another embodiment, there is provided a non-transitory computer readable recording medium having recorded thereon a computer program for implementing the image encoding method.

According to an aspect of another embodiment, there is provided a non-transitory computer readable recording medium having recorded thereon a computer program for implementing the image decoding method.

### BRIEF DESCRIPTION OF THE DRAWINGS

These and/or other aspects will become apparent and more readily appreciated from the following description of the embodiments, taken in conjunction with the accompanying drawings in which:

FIG. 1A is a block diagram of an image encoding apparatus according to an embodiment;

FIG. 1B is a flowchart of a method of encoding an image according to an embodiment;

FIG. 2A is a block diagram of an image decoding apparatus according to an embodiment;

FIG. 2B is a flowchart of a method of decoding an image according to an embodiment;

FIG. 3 is a diagram showing that a reverse scanning sequence is used for performing transformation of sub-blocks according to an embodiment;

FIG. 4 is a diagram showing that latency may be reduced when sub-blocks are transformed according to a reverse scanning sequence, according to an embodiment;

FIG. 5 is a diagram showing application of first and second transformation matrixes with respect to a sub-block, according to an embodiment;

FIGS. 6A, 6B and 6C are diagrams for describing that a first transformation matrix and a second transformation matrix are applied according to a calculation sequence during transformation of a sub-block, according to an embodiment;

FIG. 7 is a block diagram of a image encoding apparatus based on coding units according to a tree structure, according to one or more embodiments;

FIG. 8 is a block diagram of an image decoding apparatus based on coding units having a tree structure, according to one or more embodiments;

FIG. 9 is a diagram for describing a concept of coding units according to one or more embodiments;

FIG. 10 is a block diagram of an image encoder based on coding units, according to one or more embodiments;

FIG. 11 is a block diagram of an image decoder based on coding units, according to one or more embodiments;

FIG. 12 is a diagram illustrating deeper coding units according to depths, and partitions, according to one or more embodiments;

FIG. 13 is a diagram for describing a relationship between a coding unit and transformation units, according to one or more embodiments;

FIG. 14 is a diagram for describing encoding information of coding units corresponding to a depth, according to one or more embodiments;

FIG. 15 is a diagram of deeper coding units according to depths, according to one or more embodiments;

FIGS. 16, 17, and 18 are diagrams for describing a relationship between coding units, prediction units, and transformation units, according to one or more embodiments;

FIG. 19 is a diagram for describing a relationship between a coding unit, a prediction unit, and a transformation unit, according to encoding mode information of Table 1;

FIG. 20 is a diagram of a physical structure of the disc in which a program is stored, according to one or more embodiments;

FIG. 21 is a diagram of a disc drive for recording and reading a program by using the disc;

FIG. 22 is a diagram of an overall structure of a content supply system for providing a content distribution service;

FIGS. 23 and 24 illustrate an external structure and an internal structure of a mobile phone to which an image encoding method and an image decoding method are applied, according to one or more embodiments;

FIG. 25 illustrates a digital broadcasting system employing a communication system, according to one or more embodiments; and

FIG. 26 is a diagram illustrating a network structure of a cloud computing system using an image encoding apparatus and an image decoding apparatus, according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

Throughout the present specification, the terms “-er”, “-or”, “-unit”, and “module” described in the specification mean units for processing at least one function and operation and can be implemented by hardware components or software components and combinations thereof.

Reference throughout this specification to ‘some embodiments,’ ‘certain embodiments,’ ‘various embodiments’ or similar language means that a particular feature, structure, or characteristic described in connection with the embodiment is included in at least one embodiment. Thus, appearances of the phrases ‘in some embodiments’ ‘in certain embodiments,’ ‘in various embodiments,’ and similar language throughout this specification may, but do not necessarily, all refer to the same embodiment, but mean ‘one or more but not all embodiments’ unless expressly specified otherwise.

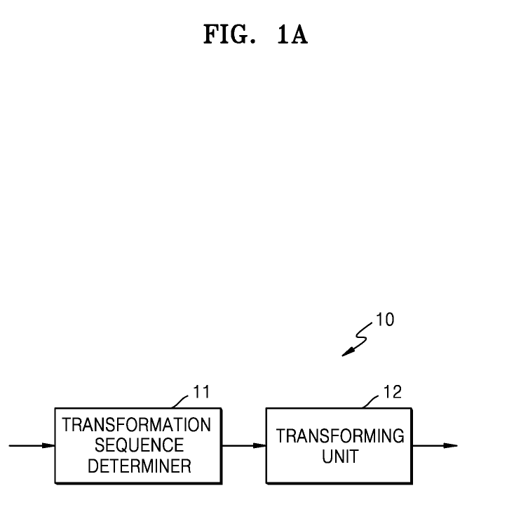

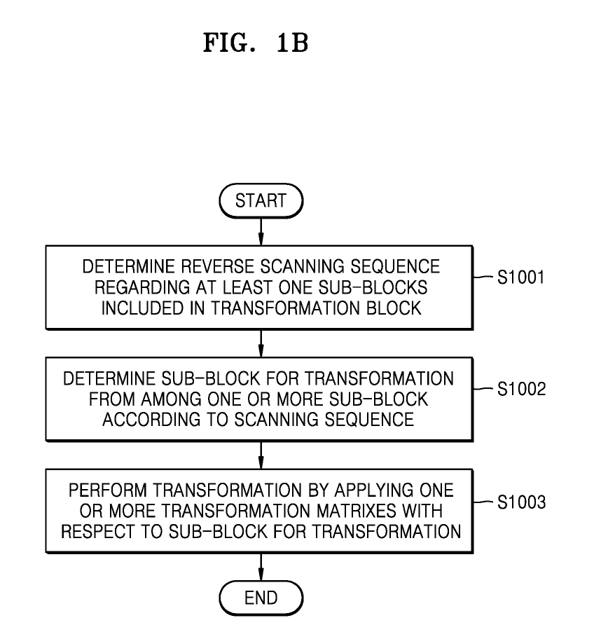

Referring to FIGS. 1A through 6, an image encoding method and an image decoding method for transformation of sub-blocks based on scan orders according to embodiments will be described.

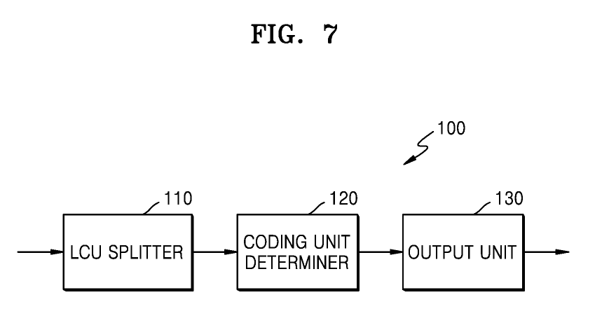

Furthermore, referring to FIGS. 7 through 26, an image encoding method and an image decoding method based on coding units according to a tree structure according to embodiments will be described. Hereinafter, the term ‘image’ may refer to a still image or a moving picture.

First, referring to FIGS. 1A through 6, an image encoding method and an image decoding method for transformation of sub-blocks based on scan orders will be described.

In order to code an image, transformation, quantization, and rate calculation may be performed with respect to coefficients in a transformation block having an arbitrary size (transformation unit; TU). Here, the rate calculation may include entropy encoding of a bit column of transformation coefficients that are quantized in order to compress an input image at a given target bit rate. Furthermore, transformation, quantization, and rate calculation with respect to coefficients in a transformation block may be performed in an arbitrary sequence. However, if a rate regarding coefficients is not calculated in a sequence defined in a syntax table of an image coding standard, coding efficiency is generally deteriorated.

An image encoding apparatus according to embodiments may perform transformation with respect to a sub-block according to a scanning sequence identical to a sequence of quantizing the sub-block and output transformed coefficients in the scanning sequence identical to the sequence of quantizing the sub-block, thereby reducing latency during residual encoding. An image decoding apparatus according to embodiments may perform inverse-transformation with respect to a sub-block consisting of parsed coefficients according to a scanning sequence identical to a sequence of inverse-quantizing the sub-block, thereby reducing latency during residual decoding

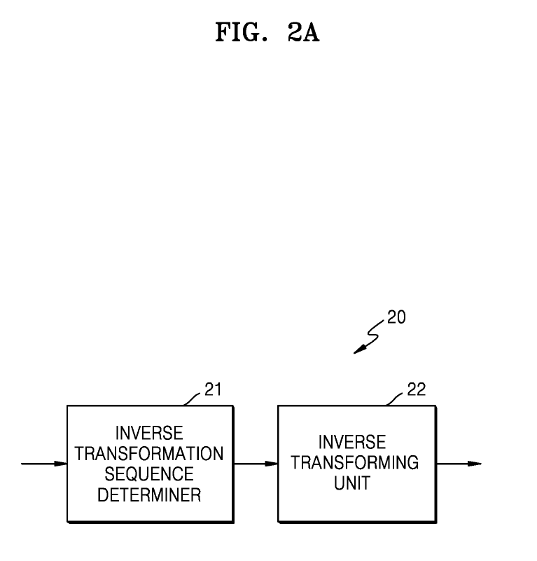

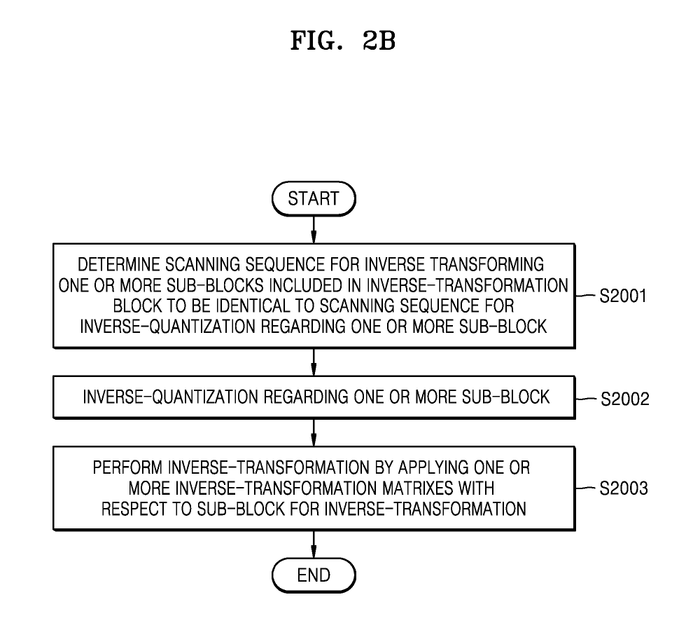

Hereinafter, operations of the image encoding apparatus 10 according to embodiments will be described with reference to FIGS. 1A and 1B, and operations of the image decoding apparatus 20 according to embodiments will be described with reference to FIGS. 2A and 2B.

FIG. 1A is a block diagram of an image encoding apparatus according to an embodiment.

Referring to FIG. 1A, an image encoding apparatus 10 according to an embodiment includes a transformation sequence determiner 11 and a transforming unit 12.

The image encoding apparatus 10 according to an embodiment receives images in units of slices or pictures, splits each of the images into blocks, and encodes each of the blocks. A block may have a square shape, a rectangular shape, or an arbitrary geometric shape. A block is not limited to a data unit having a certain size. A block according to an embodiment may be one of coding units according to a tree structure, such as a largest coding unit (LCU), a coding unit (CU), a prediction unit, or a transformation unit. Image encoding/decoding methods based on coding units according to a tree structure will be described below with reference to FIG. 7 through 26.

The image encoding apparatus 10 performs prediction regarding pixels of a target block for prediction and performs transformation of residuals of a prediction block and the target block. The transformation sequence determiner 11 determines a scanning sequence for transforming the residuals. In detail, the transformation sequence determiner 11 may determine a scanning sequence regarding one or more sub-blocks included in a transformation block. Here, the scanning sequence regarding one or more sub-blocks may be identical to a sequence for quantizing the one or more sub-blocks. Furthermore, the transformation sequence determiner 11 may determine a sub-block for transformation from among the one or more sub-blocks based on a scanning sequence. Furthermore, the transforming unit 12 may transform the sub-block for transformation by applying one or more transformation matrixes. Here, according to a syntax table defined in an image coding standard, a transformation matrix may exist in the form of a separable transform, and thus the one or more transformation matrixes may include a first transformation matrix and a second transformation matrix, which is the transposed matrix of the first transformation matrix. Meanwhile, if a transformation matrix exists in the form of a non-separable transform, the transformation matrix may exist as a single matrix.

Residual data of a transformation block or a sub-block may be arranged as a 2D array of sample difference values residing in a spatial pixel domain. A transformation transforms residual sample values into a 2D array of transformation coefficients within a transformation domain, e.g., a frequency domain. According to an embodiment, the image encoding apparatus 10 may transform sub-blocks one-by-one.

In order to transform a sub-block, the image encoding apparatus 10 may perform a scanning process for sequentially transforming one or more sub-blocks in a block according to a particular scanning sequence. In order to achieve good compression, the one or more sub-blocks may be transformed via a discrete cosine transformation (DCT), an integer transformation, a Karhunen-Loeve (K-L) transformation, etc.

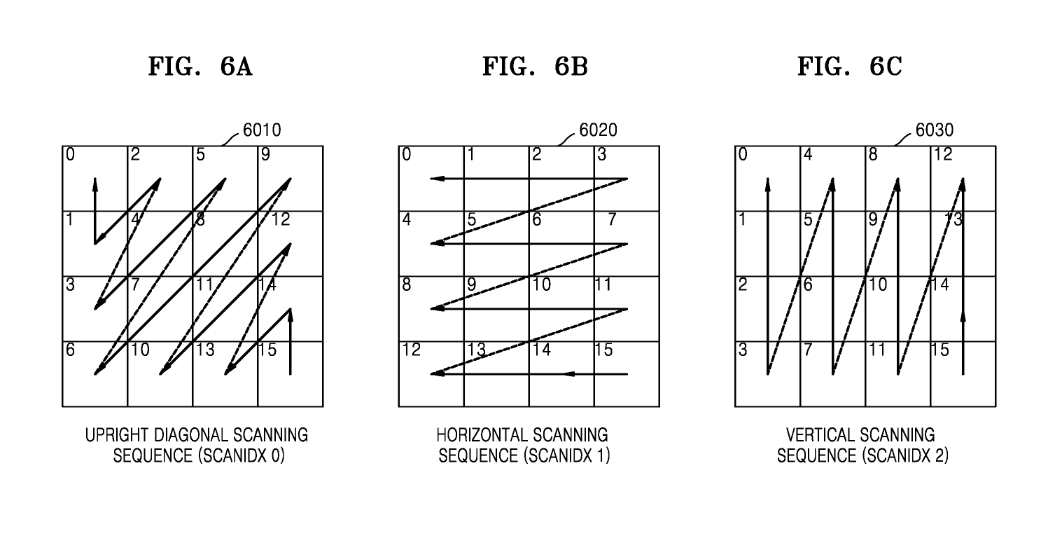

It is not necessary for a scanning sequence for transforming a sub-block to comply with a sequence defined in a syntax table of an image coding standard. For example, in the case of a syntax “transform_unit,” the syntax “transform_unit” may invoke a syntax “residual_coding,” which is a syntax element for signaling a quantized transformation coefficient of a corresponding transformation block, and the syntax “residual_coding” may signal location information regarding “last_sig_coeff.” The “last_sig_coeff” refers to the last non-zero quantization level when a transformation block is scanned in a particular scanning sequence. Here, the scanning sequence may be determined based on a prediction mode applied to the corresponding transformation block. For example, as shown in FIGS. 6A, 6B and 6C, in an inter-screen prediction mode, an upright diagonal scanning sequence 6010 may be applied. Furthermore, in an intra prediction mode for prediction in vertical directions, a vertical scanning sequence 6030 may be applied. In an intra prediction mode for prediction in horizontal directions, a horizontal scanning sequence 6020 may be applied. Accordingly, the “last_sig_coeff” defined in a syntax table may apply one of the upright diagonal scanning sequence 6010, the horizontal scanning sequence 6020, and the vertical scanning sequence 6030 to a transformation block. Furthermore, the upright diagonal scanning sequence 6010, the horizontal scanning sequence 6020, and the vertical scanning sequence 6030 may be referred to as reverse scanning sequences. However, if a rate of a transformation is calculated in a sequence different from a sequence defined in a syntax table (that is, a reverse scanning sequence), coding efficiency may be deteriorated. Detailed descriptions thereof will be given below.

In order to reduce loss of coding efficiency as much as possible, the image encoding apparatus 10 according to an embodiment may reduce an amount of buffer for coding entire residuals by performing transformation based on a same processing unit as processing units for quantization, rate calculation, and rate-distortion cost calculation that are performed in the form of pipelines after the transformation. Here, a unit for transformation may be a sub-block including 4×4 pixels, for example. However, a unit for transformation may be a pixel or a block larger than a 4×4 sub-block, e.g., a 8×8 or larger block.

Generally, amounts of calculations for quantization and rate calculation are proportional to a size of a transformation block, and thus it is easy to design a pipeline based on a same unit. Furthermore, within a single transformation block, a sequence of performing quantization does not affect results of calculations, and thus it is easy to apply a reverse scanning sequence identical to that of rate calculation to the sequence of performing quantization.

However, during an actual transformation, as the size of a transformation block increases, amounts of calculations increase geometrically and amounts of calculations vary according to sequences of performing the transformation. Therefore, in order to eliminate unnecessary calculations, a technique for re-using results of interim calculations has been suggested. However, if a sequence of performing a transformation is different from a sequence for rate calculation, it is difficult to re-use results of interim calculations and same calculations may be repeated. Therefore, amounts of calculations may not be optimized. Therefore, a transformation may be performed line-by-line.

However, when a transformation is performed line-by-line, a sequence of generating transformation coefficients is different from a sequence for rate calculation, and thus a buffer for buffering results of transformation and quantization becomes necessary to eliminate coding efficiency deterioration. In other words, if coefficients may be generated in a sequence identical to a sequence for rate calculation, an amount of buffer for storing results of transformation and quantization may be reduced or eliminated.

Units for performing a pipeline may also be configured in the manner as described above. If units for performing transformation, quantization, and rate calculation are not identical to each other, it is necessary to add buffers for achieving processing amounts of respective modules during residual coding. However, if units for performing a pipeline are identical to each other, a relatively small number of buffers are necessary for achieving processing amounts of the respective modules.

As described above, the image encoding apparatus 10 according to an embodiment may significantly reduce loss of coding efficiency by performing transformation of a sub-block in a scanning sequence identical to a sequence for quantization or rate calculation regarding the sub-block and may significantly reduce an amount of buffer for residual coding by performing transformation based on units identical to processing units for quantization, rate calculation, and rate-distortion cost calculation that are performed in the form of pipelines after the transformation.

FIG. 1B is a flowchart of a method of encoding an image according to an embodiment.

A method of encoding an image performed by the image encoding apparatus 10 according to an embodiment may include an operation S1001 for determining a scanning sequence for transforming one or more sub-blocks included in a transformation block to be identical to a sequence for quantization regarding the one or more sub-blocks, an operation S1002 for determining a sub-block for transformation from among the one or more sub-blocks according to the scanning sequence, and an operation S1003 for performing transformation of the sub-block for transformation by applying one or more transformation matrixes.

As described above, according to a syntax table defined in an image coding standard, a transformation matrix may exist in the form of separable transforms, and thus the one or more transformation matrixes may include a first transformation matrix and a second transformation matrix, which is the transposed matrix of the first transformation matrix. Furthermore, a calculation for performing transformation may be performed by multiplying a transformation block to be transformed (residual matrix X) by a first transformation matrix A and a second transformation matrix A^{T}, which is the transposed matrix of the first transformation matrix A. In other words, a transformed block Y may be defined as shown in Equation 1 below.

Y=A·X·A^{T} [Equation 1]

Furthermore, when a calculation for transformation is performed, the image encoding apparatus 10 may determine a transformation matrix to be calculated first from between a first transformation matrix and a second transformation matrix based on a scanning sequence. In detail, a sequence in which transformation matrixes are to be applied may be determined by determining calculation amounts with respect to the respective transformation matrixes to be applied. For example, if it is assumed that a sequence of performing transformation with respect to sub-blocks within a transformation block corresponds to a reverse scanning sequence, the reverse scanning sequence may include a horizontal scanning sequence, a vertical scanning sequence, and an upright diagonal scanning sequence. If the reverse scanning sequence is the horizontal scanning sequence, the image encoding apparatus 10 may obtain an interim transformation matrix by applying a first transformation matrix first and obtain a transformed block Y by applying a second transformation matrix to the obtained interim transformation matrix. Furthermore, if the reverse scanning sequence is the vertical scanning sequence or the upright diagonal scanning sequence, the image encoding apparatus 10 may obtain an interim transformation matrix by applying a second transformation matrix first and obtain a transformed block Y by applying a first transformation matrix to the obtained interim transformation matrix.

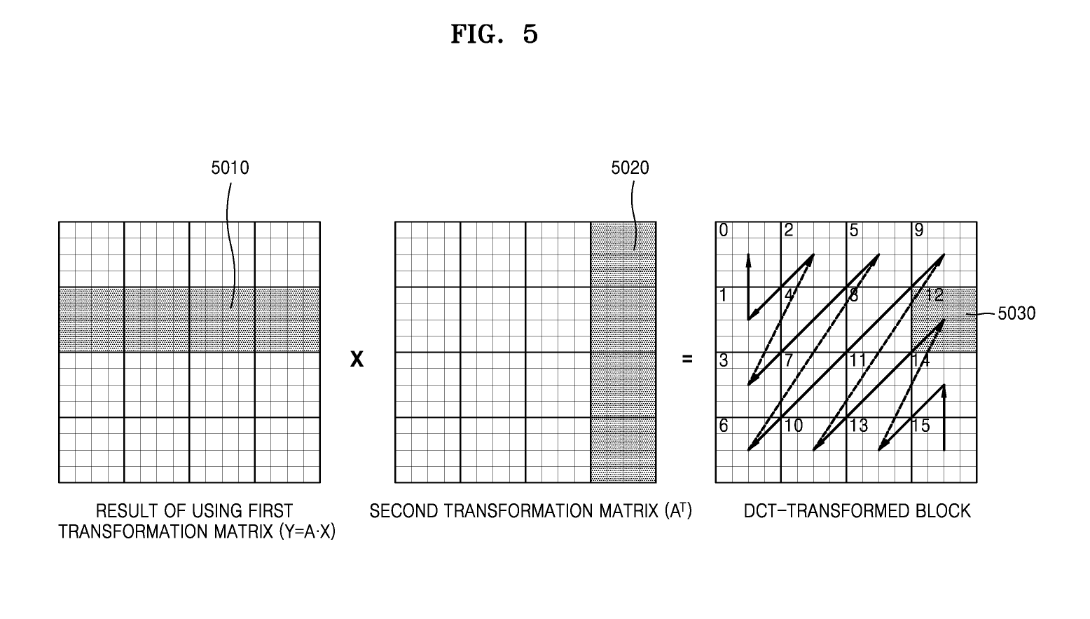

When a calculating sequence for transformation is changed according to a scanning sequence, encoding efficiency may be improved. While transformation is performed with respect to a transformation block, an interim transformation matrix may be omitted. If a scanning sequence is a reverse scanning sequence, an interim transformation matrix may be generated differently based on whether the reverse scanning sequence is a horizontal scanning sequence, a vertical scanning sequence, or an upright diagonal scanning sequence. Accordingly, the image encoding apparatus 10 according to an embodiment may obtain a transformation coefficient of a sub-block for transformation first by using an interim transformation matrix generated based on a scanning sequence, thereby improving coding efficiency. Detailed description of generation of an interim transformation matrix will be given below with respect to FIG. 5.

FIG. 2A is a block diagram of an image decoding apparatus according to an embodiment.

Referring to FIG. 2A, an image decoding apparatus 20 according to an embodiment includes an inverse-transformation sequence determiner 21 and an inverse-transforming unit 22.

In order to reconstruct an image via image decoding, the image decoding apparatus 20 may operate in conjunction with an internal image decoding processor embedded therein or an external image decoding processor, thereby performing an image decoding process. The internal image decoding processor of the image decoding apparatus 20 may be a separate processor capable of performing basic image decoding operations. Furthermore, the image decoding apparatus 20, a CPU, or a GPU may include an image decoding processing module for performing basic image decoding operations. The image decoding apparatus 20 decodes a bitstream and obtains a residual regarding a current block. A block may have a square shape, a rectangular shape, or an arbitrary geometric shape. A block is not limited to a data unit having a certain size.

The inverse-transformation sequence determiner 21 may determine a scanning sequence for inverse-transformation of one or more sub-blocks included in a transformation block consisting of parsed coefficients. Here, the scanning sequence may be identical to a sequence for inverse-quantizing the one or more sub-blocks. Furthermore, the inverse-transformation sequence determiner 21 may determine a sub-block for inverse-transformation from among the one or more sub-blocks based on a scanning sequence. Furthermore, the inverse-transforming unit 22 may inverse-transform the sub-block for inverse-transformation by applying one or more inverse-transformation matrixes.

Here, according to a syntax table defined in an image coding standard, an inverse-transformation matrix may exist in the form of separable inverse-transforms, and thus the one or more inverse-transformation matrixes may include a first inverse-transformation matrix and a second inverse-transformation matrix, which is the transposed matrix of the first inverse-transformation matrix. Meanwhile, if an inverse-transformation matrix exists in the form of a non-separable inverse-transform, the inverse-transformation matrix may exist as a single matrix.

In order to inverse-transform a sub-block, the image decoding apparatus 20 may perform a scanning process for sequentially inverse-transforming one or more sub-blocks in a block according to a particular scanning sequence. In order to achieve good compression, the one or more sub-blocks may be inverse-transformed via a discrete cosine inverse-transformation (DCT), an integer inverse-transformation, a Karhunen-Loeve (K-L) inverse-transformation, etc.

In order to reduce loss of coding efficiency as much as possible, the image decoding apparatus 20 according to an embodiment may reduce a necessary amount of buffer by performing inverse-transformation based on a same processing unit as processing units for quantization, rate calculation, and rate-distortion cost calculation that are performed in the form of pipelines before the inverse-transformation. Here, a unit for inverse-transformation may be a sub-block including 4×4 pixels, for example. However, a unit for inverse-transformation may be a pixel or a block larger than a 4×4 sub-block, e.g., a 8×8 or larger block.

FIG. 2B is a flowchart of a method of decoding an image according to an embodiment.

A method of decoding an image performed by the image decoding apparatus 20 according to an embodiment may include an operation S2001 for determining a scanning sequence for inverse-transforming one or more sub-blocks included in an inverse-transformation block to be identical to a sequence for quantization regarding the one or more sub-blocks, an operation S2002 for determining a sub-block for inverse-transformation from among the one or more sub-blocks according to the scanning sequence, and an operation S2003 for performing inverse-transformation of the sub-block for inverse-transformation by applying one or more inverse-transformation matrixes.

As described above, according to a syntax table defined in an image coding standard, an inverse-transformation matrix may exist in the form of separable inverse-transforms, and thus the one or more inverse-transformation matrixes may include a first inverse-transformation matrix and a second inverse-transformation matrix, which is the transposed matrix of the first inverse-transformation matrix. Furthermore, a calculation for performing inverse-transformation may be performed by multiplying a block Y to be inverse-transformed by a first inverse-transformation matrix B and a second inverse-transformation matrix B^{T}, which is the transposed matrix of the first inverse-transformation matrix B. In other words, an inverse-transformed block X may be defined as shown in Equation 1 below.

X=B·Y·B^{T} [Equation 2]

Furthermore, when a calculation for inverse-transformation is performed, the image decoding apparatus 20 may determine an inverse-transformation matrix to be calculated first from between a first inverse-transformation matrix and a second inverse-transformation matrix based on a scanning sequence. In detail, a sequence in which inverse-transformation matrixes are to be applied may be determined by determining calculation amounts with respect to the respective transformation matrixes to be applied. For example, if it is assumed that a sequence of performing inverse-transformation with respect to sub-blocks within an inverse-transformation block corresponds to a reverse scanning sequence, the reverse scanning sequence may include a horizontal scanning sequence, a vertical scanning sequence, and an upright diagonal scanning sequence. If the reverse scanning sequence is the horizontal scanning sequence, the image decoding apparatus 20 may obtain an interim inverse-transformation matrix by applying a first inverse-transformation matrix first and obtain an inverse-transformed block X by applying a second inverse-transformation matrix to the obtained interim inverse-transformation matrix. Furthermore, if the reverse scanning sequence is the vertical scanning sequence or the upright diagonal scanning sequence, the image decoding apparatus 20 may obtain an interim inverse-transformation matrix by applying a second inverse-transformation matrix first and obtain an inverse-transformed block X by applying a first inverse-transformation matrix to the obtained interim inverse-transformation matrix

Furthermore, when a calculating sequence for inverse-transformation is changed according to a scanning sequence, decoding efficiency may be improved. While inverse-transformation is performed with respect to an inverse-transformation block, an interim inverse-transformation matrix may be omitted. If a scanning sequence is a reverse scanning sequence, an interim inverse-transformation matrix may be generated differently based on whether the reverse scanning sequence is a horizontal scanning sequence, a vertical scanning sequence, or an upright diagonal scanning sequence. Accordingly, the image decoding apparatus 20 according to an embodiment may obtain an inverse-transformation coefficient of a sub-block for inverse-transformation first by using an interim inverse-transformation matrix generated based on a scanning sequence, thereby improving decoding efficiency. An interim inverse-transformation matrix may be generated in correspondence to the interim transformation matrix described above with reference to FIG. 1B. Therefore, detailed description of generation of an interim inverse-transformation matrix will be replaced with the description of the generation of an interim transformation matrix of FIG. 5.

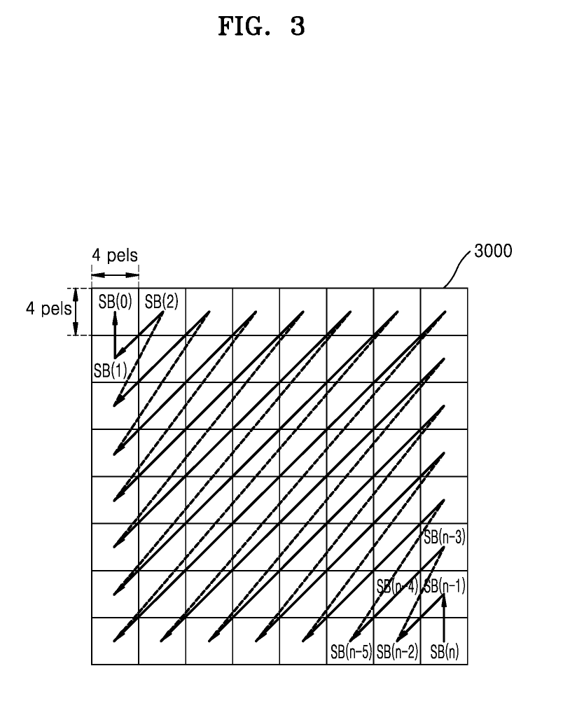

FIG. 3 is a diagram showing that a reverse scanning sequence is used for performing transformation of sub-blocks according to an embodiment.

Although a transformation block 3000 shown in FIG. 3 include 32×32 pixels, it is not necessary for the transformation block 3000 according to an embodiment to include 32×32 pixels and the number of pixels included in the transformation block 3000 may be smaller or larger than 32×32 pixels. Furthermore, although FIG. 3 shows that each sub-block of the transformation block 3000 includes 4×4 pixels, the inventive concept is not limited thereto. The reverse scanning sequence shown in FIG. 3 is an upright diagonal scanning sequence. When transformation regarding a sub-block is performed according to an upright diagonal scanning sequence, sub-blocks may be scanned in the order of SB(n), SB(n-1), SB(n-2), . . . , SB(2), SB(1), and SB(0) along the direction indicated by the arrow in FIG. 3, where the sub-blocks may be transformed in the same order.

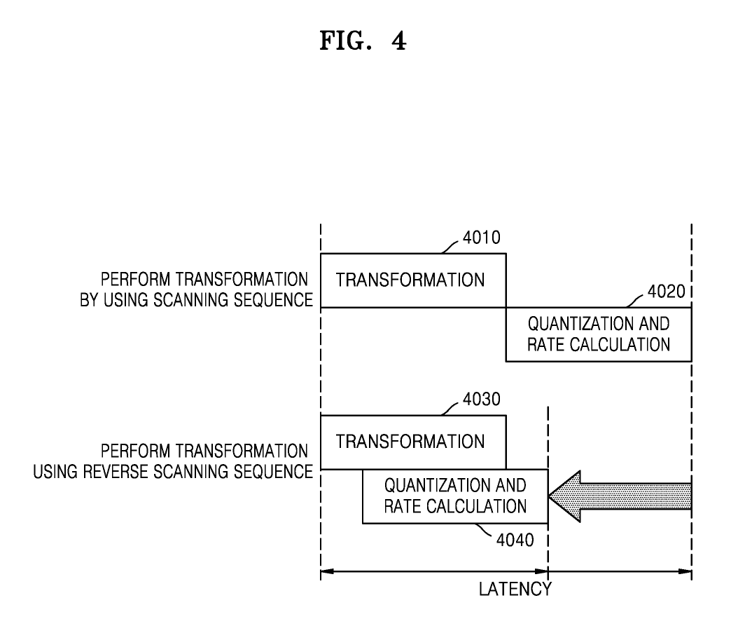

FIG. 4 is a diagram showing that latency may be reduced when sub-blocks are transformed according to a reverse scanning sequence, according to an embodiment.

The image encoding apparatus 10 according to an embodiment may perform transformation, quantization, and rate calculation (residual coding) with respect to coefficients within a transformation block having an arbitrary size. Here, transformation, quantization, and rate calculation with respect to coefficients in a transformation block may be performed in an arbitrary sequence. For example, as a sequence for rate calculation, a syntax “residual_coding” defined in a syntax table of an image coding standard may be invoked. The syntax “residual_coding” may signal location information regarding “last_sig_coeff,” where the “last_sig_coeff” refers to the last non-zero quantization level when a transformation block is scanned in a particular scanning sequence. Here, a scanning sequence may be determined based on a prediction mode applied to a corresponding transformation block. For example, as shown in FIGS. 6A, 6B and 6C, in an inter-screen prediction mode, an upright diagonal scanning sequence 6010 may be applied. Furthermore, in an intra prediction mode for prediction in vertical directions, a vertical scanning sequence 6030 may be applied. In an intra prediction mode for prediction in horizontal directions, a horizontal scanning sequence 6020 may be applied.

Referring to FIG. 4, when transformation 4010 is performed with respect to a sub-block by using a scanning sequence, which is not a reverse scanning sequence, a sequence for the transformation is different from those for quantization and rate calculation 4020 that are performed according to reverse scanning sequences, a transformed coefficient may be used as an initial input for the quantization and rate calculation 4020 only after the transformation 4010 is completed.

On the contrary, when the image encoding apparatus 10 according to an embodiment performs transformation 4030 by using a reverse scanning sequence, a sequence for the transformation 4030 is identical to those for quantization and rate calculation 4040 performed by using a reverse scanning sequence, and thus a transformed coefficient may be used as an input for the quantization and rate calculation 4040 during the transformation 4030. Accordingly, when transformation is performed by using a reverse scanning sequence, the transformation may be performed in the form of a pipeline together with quantization and rate calculation. When transformation, quantization, and rate calculation are performed in the form of a pipeline, the overall latency may be reduced and the number of buffers may be significantly reduced. Therefore, hardware efficiency may be improved.

FIG. 5 is a diagram showing application of first and second transformation matrixes with respect to a sub-block, according to an embodiment.

A calculation for transformation is performed by multiplying a transformation block X by a first transformation matrix A and a second transformation matrix A^{T}, which is the transposed matrix of the first transformation matrix A. For example, a sub-block located at x^{th} row and y^{th} column will be referred to as a sub-block (x, y). When transformation is performed with respect to the sub-block (x, y), an interim transformation matrix may be generated and data 5010 regarding sub-blocks at the x^{th} row may be calculated by applying a first transformation matrix A to a transformation block X. Next, a transformed sub-block (x, y) may be obtained by multiplying the data 5010 regarding sub-blocks at the x^{th} row of the generated interim transformation matrix by data 5020 regarding sub-blocks at the y^{th} column of a second transformation matrix A^{T} (5030). Here, the data 5010 regarding sub-blocks at the x^{th} row of the generated interim transformation matrix may be re-used later for transformation of sub-blocks for transformation.

FIGS. 6A, 6B and 6C are diagrams for describing that a first transformation matrix and a second transformation matrix are applied according to a calculation sequence during transformation of a sub-block, according to an embodiment.

A calculation for transformation may be performed by multiplying a transformation block to be transformed (residual matrix X) by a first transformation matrix A and a second transformation matrix A^{T}, which is the transposed matrix of the first transformation matrix A (refer to Equation 1). The image encoding apparatus 10 according to an embodiment may determine a transformation matrix to be applied to a transformation block first from between a first transformation matrix and a second transformation matrix based on a scanning sequence. For example, if it is assumed that a sequence of performing transformation with respect to a transformation block corresponds to a reverse scanning sequence, the reverse scanning sequence may include a horizontal scanning sequence 6020, a vertical scanning sequence 6030, and an upright scanning sequence 6010. If the reverse scanning sequence is the horizontal scanning sequence 6020, the image encoding apparatus 10 may obtain an interim transformation matrix Y′ by applying a first transformation matrix first and obtain a transformed block Y by applying a second transformation matrix to the obtained interim transformation matrix Y′ (refer to Equation 3). Furthermore, if the reverse scanning sequence is the vertical scanning sequence 6030 or the upright diagonal scanning sequence 6010, the image encoding apparatus 10 may obtain an interim transformation matrix Y′ by applying a second transformation matrix first and obtain a transformed block Y by applying a first transformation matrix to the obtained interim transformation matrix Y′ (refer to Equation 4).

Y′=A·X Y=Y′·A^{T} [Equation 3]

Y″=X·A^{T}Y=A·Y″ [Equation 4]

Accordingly, a sequence for calculating a first transformation matrix and a second transformation matrix may be changed based on whether a reverse scanning sequence is the horizontal scanning sequence 6020, the vertical scanning sequence 6030, or the upright scanning sequence 6010, and thus a transformation coefficient of a sub-block for transformation may be obtained first.

As described above, in the image encoding apparatus 10 and the image decoding apparatus 20 according to embodiments, each of blocks divided from an image is divided into LCUs, where each of the LCUs may be encoded/decoded based on coding units according to a tree structure. Hereinafter, referring to FIGS. 7 through 26, image encoding methods and image decoding methods based on coding units according to a tree structure according to one or more embodiments will be described.

FIG. 7 is a block diagram of an image encoding apparatus 100 based on coding units according to a tree structure, according to one or more embodiments. The image encoding apparatus 100 shown in FIG. 7 may correspond to the image encoding apparatus 10 of FIG. 1A described above, where the transformation sequence determiner 11 and the transformer 12 included in the image encoding apparatus 10 may be included as components of a coding unit determiner 120 and perform respective functions.

According to one or more embodiments, the image encoding apparatus 100 involving video prediction based on coding units according to a tree structure includes a LCU splitter 110, the coding unit determiner 120, and an output unit 130. For convenience of explanation, the ‘image encoding apparatus 100 involving video prediction based on coding units according to a tree structure according to one or more embodiments’ will be referred to as the ‘image encoding apparatus 100.’

The LCU splitter 110 may split a current picture based on a LCU that is a coding unit having a maximum size for a current picture of an image. If the current picture is larger than the LCU, image data of the current picture may be split into the at least one LCU. The LCU according to one or more embodiments may be a data unit having a size of 32×32, 64×64, 128×128, 256×256, etc., wherein a shape of the data unit is a square having a width and length in squares of 2. The image data may be output to the coding unit determiner 120 according to the at least one LCU.

A coding unit according to one or more embodiments may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to one or more embodiments is split according to depths, the image data of the spatial domain included in the LCU may be hierarchically classified according to depths.

A maximum depth and a maximum size of a coding unit, which limit the total number of times a height and a width of the LCU are hierarchically split, may be certain.

The coding unit determiner 120 encodes at least one split region obtained by splitting a region of the LCU according to depths, and determines a depth to output a finally encoded image data according to the at least one split region. In other words, the coding unit determiner 120 determines a depth by encoding the image data in the deeper coding units according to depths, according to the LCU of the current picture, and selecting a depth having the least encoding error. The determined depth and the encoded image data according to the determined depth are output to the output unit 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the depths may differ according to regions in the image data. Thus, one or more depths may be determined in one LCU, and the image data of the LCU may be divided according to coding units of at least one depth.

Accordingly, the coding unit determiner 120 may determine coding units having a tree structure included in the LCU. The ‘coding units having a tree structure’ according to one or more embodiments include coding units corresponding to a depth determined to be the depth, from among all deeper coding units included in the LCU. A coding unit of a depth may be hierarchically determined according to depths in the same region of the LCU, and may be independently determined in different regions. Similarly, a depth in a current region may be independently determined from a depth in another region.

A maximum depth according to one or more embodiments is an index related to the number of splitting times from a LCU to an SCU. A first maximum depth according to one or more embodiments may denote the total number of splitting times from the LCU to the SCU. A second maximum depth according to one or more embodiments may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in a LCU.

The image encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the image encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a depth, i.e., based on a coding unit that is no longer split to coding units corresponding to a lower depth. Hereinafter, a coding unit that becomes the basis of a prediction encoding and is no longer split to coding units corresponding to a lower depth will be referred to as a ‘prediction unit.’ The prediction unit may include the coding unit and a partition obtained by splitting at least one of a height and a width of the coding unit. A partition is a data unit where a prediction unit of a coding unit is split and may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The image encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residues in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a depth requires not only information about the depth, but also about information related to prediction encoding and transformation. Accordingly, the coding unit determiner 120 not only determines a depth having a least encoding error, but also determines a partition mode in a prediction unit, a prediction mode according to prediction units, and a size of a transformation unit for transformation.

Coding units according to a tree structure in a LCU and methods of determining a prediction unit/partition, and a transformation unit, according to one or more embodiments, will be described in detail below with reference to FIG. 7 through 19.

The coding unit determiner 120 may measure an encoding error of deeper coding units according to depths by using Rate-Distortion Optimization based on Lagrangian multipliers.

The output unit 130 outputs the image data of the LCU, which is encoded based on the at least one depth determined by the coding unit determiner 120, and information about the encoding mode according to the depth, in bitstreams.

The encoded image data may be obtained by encoding residues of an image.

The information about the encoding mode according to depth may include information about the depth, about the partition mode in the prediction unit, the prediction mode, and the size of the transformation unit.

The information about the depth may be defined by using splitting information according to depths, which indicates whether encoding is performed on coding units of a lower depth instead of a current depth. If the current depth of the current coding unit is the depth, image data in the current coding unit is encoded and output, and thus the splitting information may be defined not to split the current coding unit to a lower depth. Alternatively, if the current depth of the current coding unit is not the depth, the encoding is performed on the coding unit of the lower depth, and thus the splitting information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and information about at least one encoding mode is determined for a coding unit of a depth, information about at least one encoding mode may be determined for one LCU. Also, a depth of the image data of the LCU may be different according to locations since the image data is hierarchically split according to depths, and thus splitting information may be set for the image data.

Accordingly, the output unit 130 may assign corresponding splitting information to at least one of the coding unit, the prediction unit, and a minimum unit included in the LCU.

The minimum unit according to one or more embodiments is a square data unit obtained by splitting the SCU constituting the lowermost depth by 4. Alternatively, the minimum unit according to an embodiment may be a maximum square data unit that may be included in all of the coding units, prediction units, partition units, and transformation units included in the LCU.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Furthermore, information about a maximum size of the transformation unit permitted with respect to a current image, and information about a minimum size of the transformation unit may also be output through a header of a bitstream, a sequence parameter set, or a picture parameter set. The output unit 130 may encode and output SAO parameters related to the SAO operation described above with reference to FIGS. 1A through 14.

In the image encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the image encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the image encoding apparatus 100, image compression efficiency may be increased since a coding unit is adjusted while considering characteristics of an image while increasing a maximum size of a coding unit while considering a size of the image.

The image encoding apparatus 100 of FIG. 7 may perform the operations of the image encoding apparatuses 10 and 30 described above with reference to FIGS. 1A and 6.

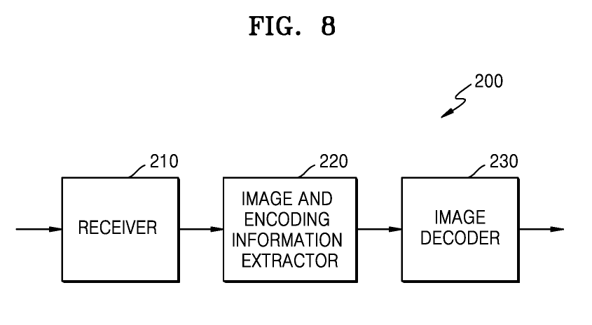

FIG. 8 is a block diagram of an image decoding apparatus 200 based on coding units having a tree structure, according to one or more embodiments. The image decoding apparatus 200 shown in FIG. 8 may correspond to the image decoding apparatus 20 of FIG. 2A described above, where an image data decoder 230 included in the image decoding apparatus 200 may include the inverse-transformation sequence determiner 21 and the inverse-transformer 22 included in the image decoding apparatus 20.

The image decoding apparatus 200 that involves image prediction based on coding units having a tree structure according to one or more embodiments includes a receiver 210, an image data and encoding information extractor 220, and an image data decoder 230. For convenience of explanation, the ‘image decoding apparatus 200 involving image prediction based on coding units according to a tree structure according to one or more embodiments’ will be referred to as the ‘image decoding apparatus 200.’

Definitions of various terms, such as a coding unit, a depth, a prediction unit, a transformation unit, and information about various encoding modes, for decoding operations of the image decoding apparatus 200 are identical to those described with reference to FIG. 7# and the image encoding apparatus 100.

The receiver 210 receives and parses a bitstream of an encoded image. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts depth and splitting information for the coding units having a tree structure according to each LCU, from the parsed bitstream. The extracted depth and splitting information is output to the image data decoder 230. In other words, the image data in a bit stream is split into the LCU so that the image data decoder 230 decodes the image data for each LCU.

The depth and splitting information according to the LCU may be set for at least one piece of depth information corresponding to the depth, and encoding information according to the depth may include information about a partition mode of a corresponding coding unit corresponding to the depth, information about a prediction mode, and splitting information of a transformation unit. Also, splitting information according to depths may be extracted as the information about a depth.

The depth and splitting information according to each LCU extracted by the image data and encoding information extractor 220 is depth and splitting information determined to generate a minimum encoding error when an encoder, such as the image encoding apparatus 100, repeatedly performs encoding for each deeper coding unit according to depths according to each LCU. Accordingly, the image decoding apparatus 200 may reconstruct an image by decoding the image data according to a depth and an encoding mode that generates the minimum encoding error.

Since the depth and splitting information may be assigned to a certain data unit from among a corresponding coding unit, a prediction unit, and a minimum unit, the image data and encoding information extractor 220 may extract the depth and splitting information according to the certain data units. If depth and splitting information of a corresponding LCU are recorded according to certain data units, the certain data units to which the same depth and splitting information are assigned may be inferred to be the data units included in the same LCU.

The image data decoder 230 reconstructs the current picture by decoding the image data in each LCU based on the depth and splitting information according to the LCUs. In other words, the image data decoder 230 may decode the encoded image data based on the extracted information about the partition mode, the prediction mode, and the transformation unit for each coding unit from among the coding units having the tree structure included in each LCU. A decoding process may include a prediction including intra prediction and motion compensation, and an inverse-transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse-transformation based on transformation units for each coding unit, for inverse-transformation for each LCU. Via the inverse-transformation, a pixel value of the spatial domain of the coding unit may be reconstructed.

The image data decoder 230 may determine a final depth of a current LCU by using splitting information according to depths. If the splitting information indicates that image data is no longer split in the current depth, the current depth is the final depth. Accordingly, the image data decoder 230 may decode encoded data in the current LCU by using the information about the partition mode of the prediction unit, the information about the prediction mode, and the splitting information of the transformation unit for each coding unit corresponding to the depth.

In other words, data units containing the encoding information including the same splitting information may be gathered by observing the encoding information set assigned for the certain data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

Furthermore, the image decoding apparatus 200 of FIG. 8 may perform the operations of the image decoding apparatuses 20 and 40 described above with reference to FIG. 2A.

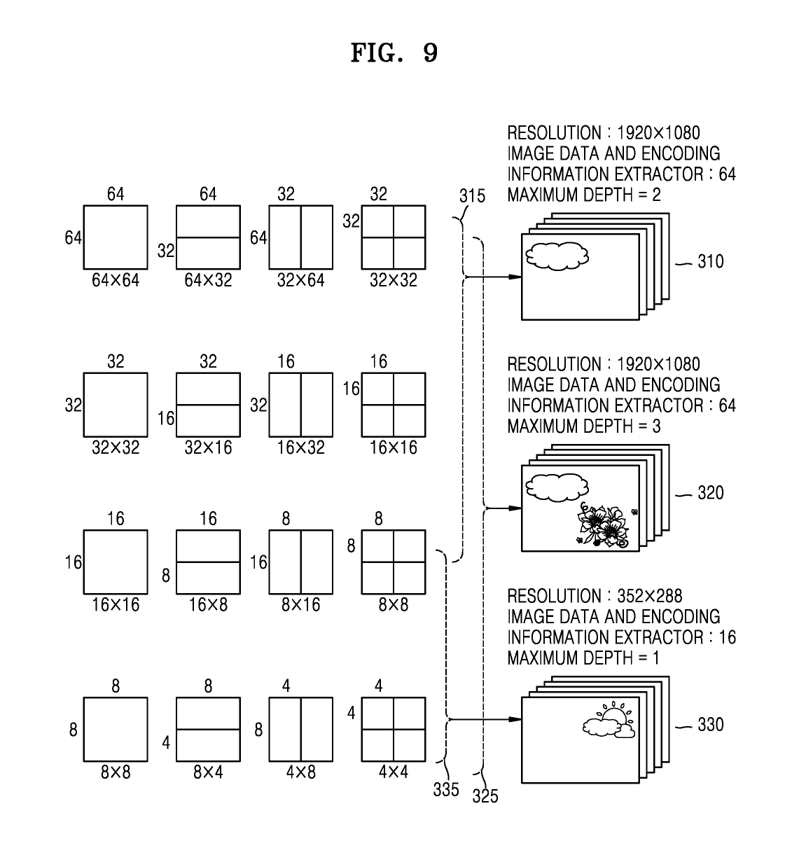

FIG. 9 is a diagram for describing a concept of coding units according to one or more embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

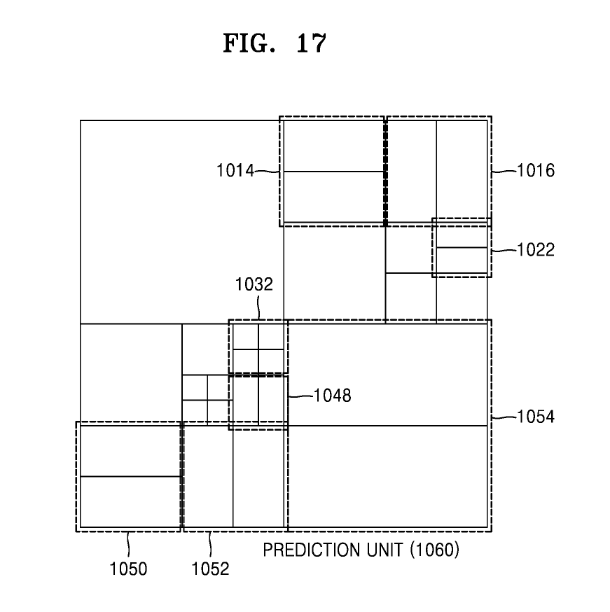

In image data 310, a resolution is 1920×1080, a maximum size of a coding unit is 64, and a maximum depth is 2. In image data 320, a resolution is 1920×1080, a maximum size of a coding unit is 64, and a maximum depth is 3. In image data 330, a resolution is 352×288, a maximum size of a coding unit is 16, and a maximum depth is 1. The maximum depth shown in FIG. 17 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the image data 310 and 320 having a higher resolution than the image data 330 may be 64.

Since the maximum depth of the image data 310 is 2, coding units 315 of the vide data 310 may include a LCU having a long axis size of 64, and coding units having long axis sizes of 32 and 16 since depths are deepened to two layers by splitting the LCU twice. Since the maximum depth of the image data 330 is 1, coding units 335 of the image data 330 may include a LCU having a long axis size of 16, and coding units having a long axis size of 8 since depths are deepened to one layer by splitting the LCU once.

Since the maximum depth of the image data 320 is 3, coding units 325 of the image data 320 may include a LCU having a long axis size of 64, and coding units having long axis sizes of 32, 16, and 8 since the depths are deepened to 3 layers by splitting the LCU three times. As a depth deepens, detailed information may be precisely expressed.

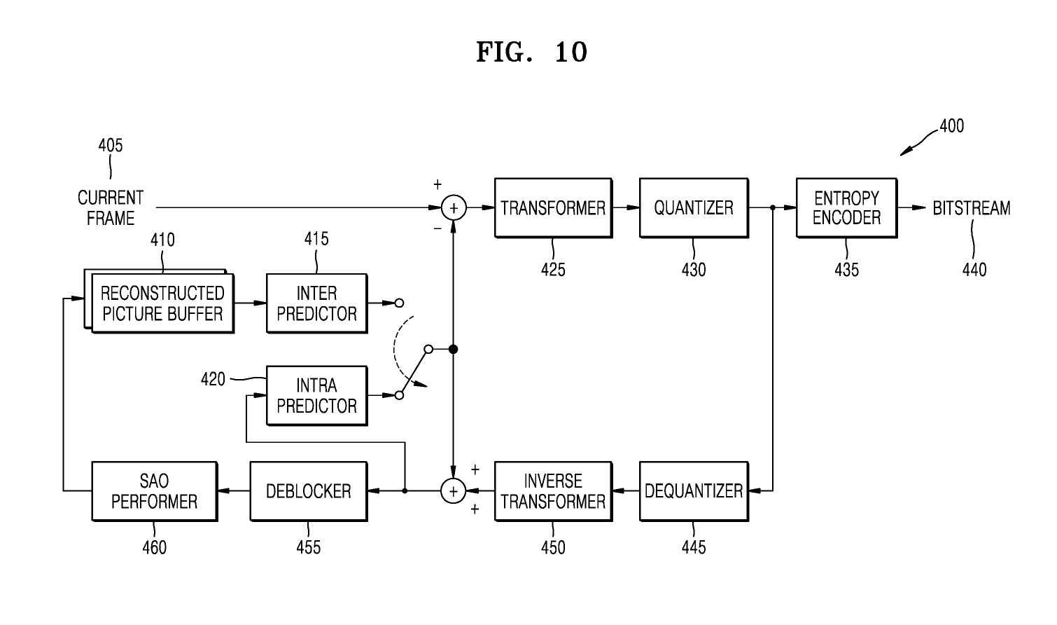

FIG. 10 is a block diagram of an image encoder 400 based on coding units, according to one or more embodiments.

The image encoder 400 performs operations necessary for encoding image data in the coding unit determiner 120 of the image encoding apparatus 100. In other words, an intra predictor 420 performs intra prediction on coding units in an intra mode according to prediction units, from among a current frame 405, and an inter predictor 415 performs inter prediction on coding units in an inter mode by using a current image 405 and a reference image obtained from a reconstructed picture buffer 410 according to prediction units. The current image 405 may be split into LCUs and then the LCUs may be sequentially encoded. In this regard, the LCUs that are to be split into coding units having a tree structure may be encoded.

Residue data is generated by removing prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residue data in a spatial domain through a dequantizer 445 and an inverse-transformer 450. The reconstructed residue data in the spatial domain is added to prediction data for coding units of each mode that is output from the intra predictor 420 or the inter predictor and thus is reconstructed as data in a spatial domain for coding units of the current image 405. The reconstructed data in the spatial domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435. The residue data transformer 425 may correspond to the transformation sequence determiner 11 and the transforming unit 12 of FIG. 1A, whereas the inverse-transformer 450 may correspond to the inverse-transformation sequence determiner 21 and the inverse-transforming unit 22 of FIG. 2A.

In order for the image encoder 400 to be applied in the image encoding apparatus 100, all elements of the image encoder 400, i.e., the inter predictor 415, the intra predictor 420, the transformer 425, the quantizer 430, the entropy encoder 435, the dequantizer 445, the inverse-transformer 450, the de-blocker 455, and the SAO performer 460, perform operations based on each coding unit among coding units having a tree structure according to each LCU.

In particular, the intra predictor 410, the motion estimator 420, and the motion compensator 425 determines partitions and a prediction mode of each coding unit from among the coding units having a tree structure while considering the maximum size and the maximum depth of a current LCU, and the transformer 430 determines the size of the transformation unit in each coding unit from among the coding units having a tree structure.

Specifically, the intra predictor 420 and the inter predictor 415 may determine a partition mode and a prediction mode of each coding unit among the coding units having a tree structure in consideration of a maximum size and a maximum depth of a current LCU, and the transformer 425 may determine whether to split a transformation unit having a quad tree structure in each coding unit among the coding units having a tree structure.

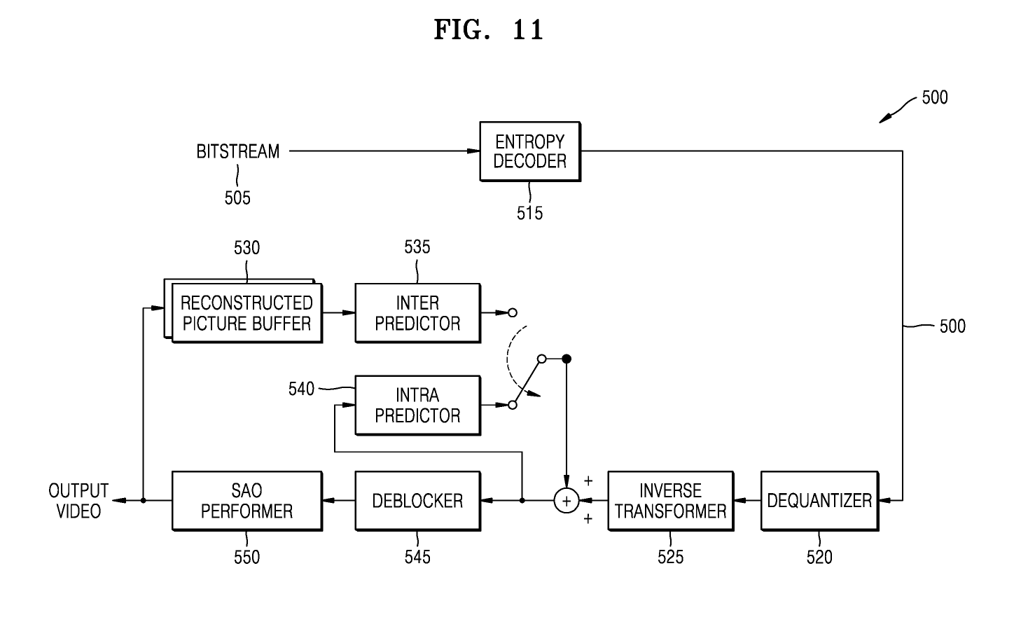

FIG. 11 is a block diagram of an image decoder 500 based on coding units, according to one or more embodiments.

An entropy decoder 515 parses encoded image data to be decoded and information about encoding required for decoding from a bitstream 505. The encoded image data is a quantized transformation coefficient from which residue data is reconstructed by a dequantizer 520 and an inverse-transformer 525. The inverse-transformer 525 may correspond to the inverse-transformation sequence determiner 21 and the inverse-transforming unit 22 of FIG. 2A.

An intra predictor 540 performs intra prediction on coding units in an intra mode according to each prediction unit. An inter predictor 535 performs inter prediction on coding units in an inter mode from among the current image 405 for each prediction unit by using a reference image obtained from a reconstructed picture buffer 530.

Prediction data and residue data regarding coding units of each mode, which passed through the intra predictor 540 and the inter predictor 535, are summed, and thus data in a spatial domain regarding coding units of the current image 405 may be reconstructed, and the reconstructed data in the spatial domain may be output as a reconstructed image 560 through a de-blocker 545 and a sample compensator 550. Reconstructed images stored in the reconstructed picture buffer 530 may be output as reference images.

In order to decode the image data in the image data decoder 230 of the image decoding apparatus 200, operations after the entropy decoder 515 of the image decoder 500 according to an embodiment may be performed.

In order for the image decoder 500 to be applied in the image decoding apparatus 200 according to an embodiment, all elements of the image decoder 500, i.e., the entropy decoder 515, the dequantizer 520, the inverse-transformer 525, the inter predictor 535, the de-blocker 545, and the sample compensator 550 may perform operations based on coding units having a tree structure for each LCU.

In particular, the sample compensator 550 and the inter predictor 535 may determine a partition and a prediction mode for each of the coding units having a tree structure, and the inverse-transformer 525 may determine whether to split a transformation unit having a quad tree structure for each of the coding units.

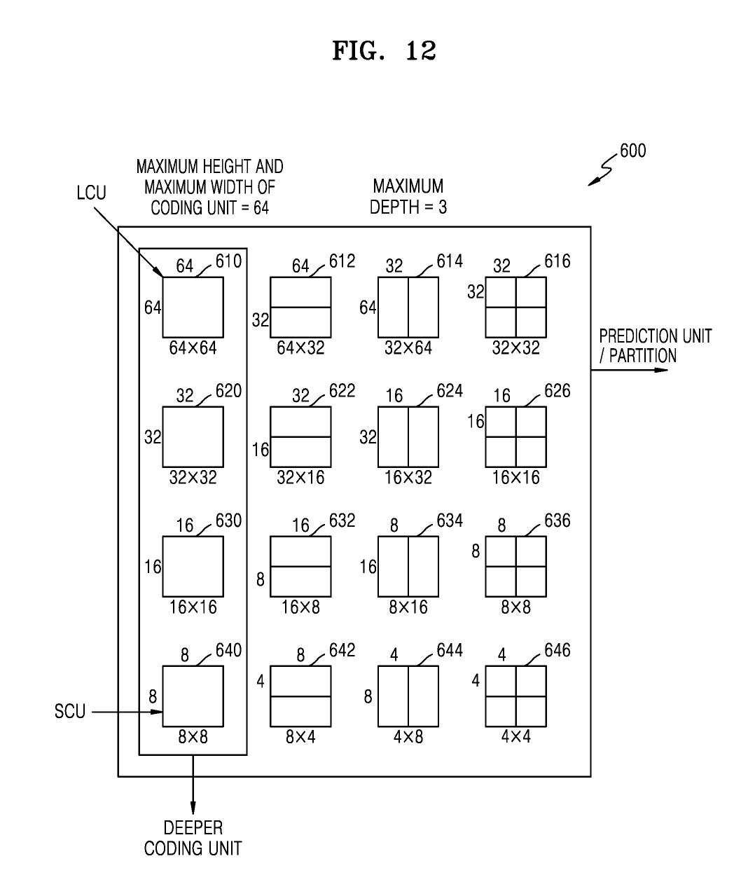

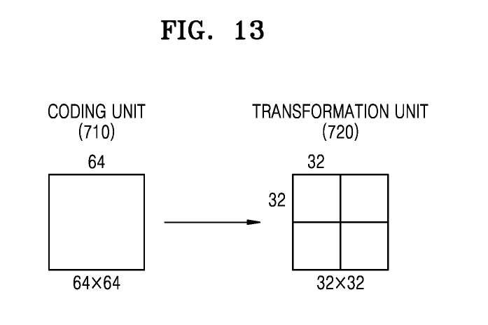

FIG. 12 is a diagram illustrating deeper coding units according to depths, and partitions, according to one or more embodiments.

The image encoding apparatus 100 and the image decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the certain maximum size of the coding unit.

In a hierarchical structure 600 of coding units, according to one or more embodiments, the maximum height and the maximum width of the coding units are each 64, and the maximum depth is 3. In this case, the maximum depth refers to a total number of times the coding unit is split from the LCU to the SCU. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine a final depth of the coding units constituting the LCU 610, the coding unit determiner 120 of the image encoding apparatus 100 performs encoding for coding units corresponding to each depth included in the LCU 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the final depth and a partition mode of the coding unit 610.

FIG. 13 is a diagram for describing a relationship between a coding unit 710 and transformation units 720, according to one or more embodiments.

The image encoding apparatus 100 or the image decoding apparatus 200 encodes or decodes an image according to coding units having sizes smaller than or equal to a LCU for each LCU. Sizes of transformation units for transformation during encoding may be selected based on data units that are not larger than a corresponding coding unit.

For example, in the image encoding apparatus 100 or the image decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

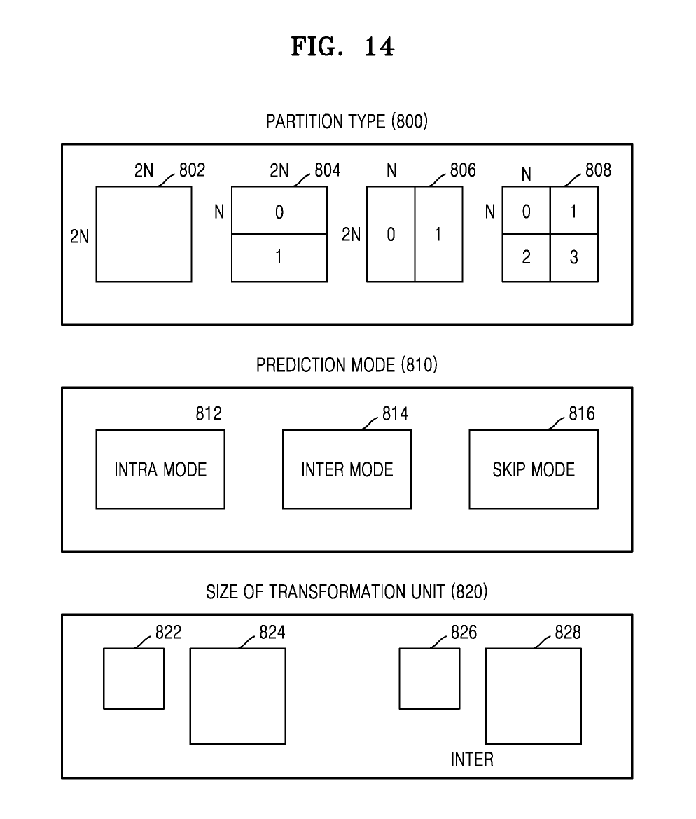

FIG. 14 is a diagram for describing encoding information of coding units corresponding to a depth, according to one or more embodiments.

The output unit 130 of the image encoding apparatus 100 may encode and transmit information 800 about a partition mode, information 810 about a prediction mode, and information 820 about a size of a transformation unit for each coding unit corresponding to a final depth, as information about an encoding mode.

The information 800 indicates information about a mode of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition mode is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the image decoding apparatus 200 may extract and use the information 800, 810, and 820 for decoding, according to each deeper coding unit.

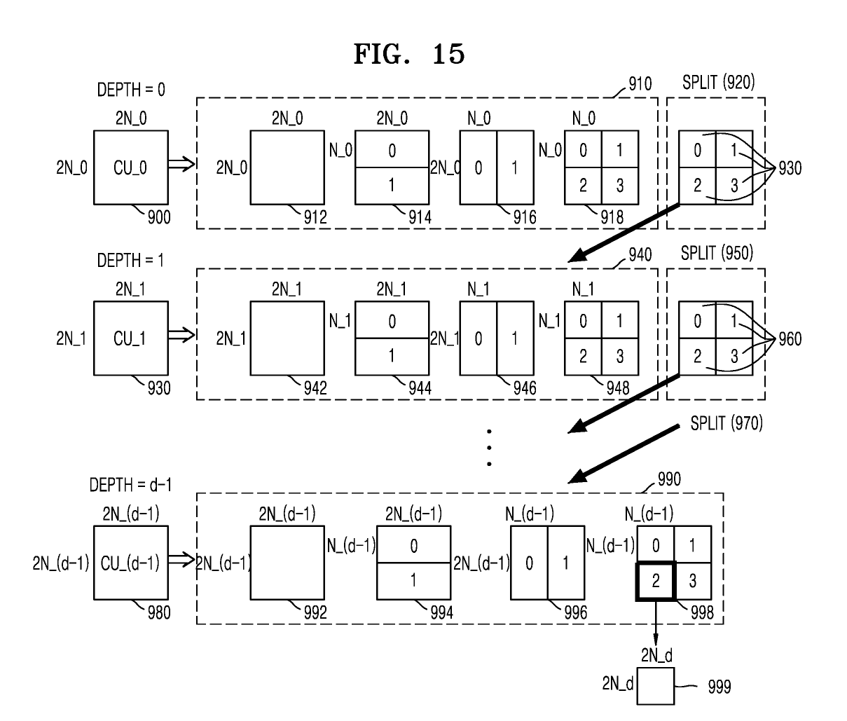

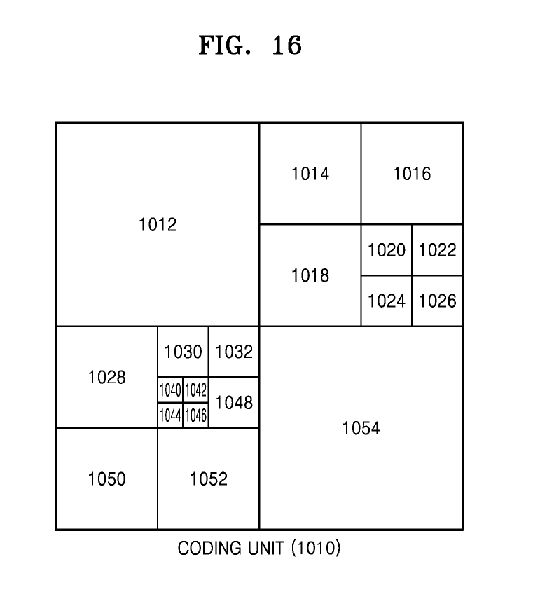

FIG. 15 is a diagram of deeper coding units according to depths, according to one or more embodiments.

Splitting information may be used to indicate a change of a depth. The spilt information indicates whether a coding unit of a current depth is split into coding units of a lower depth.

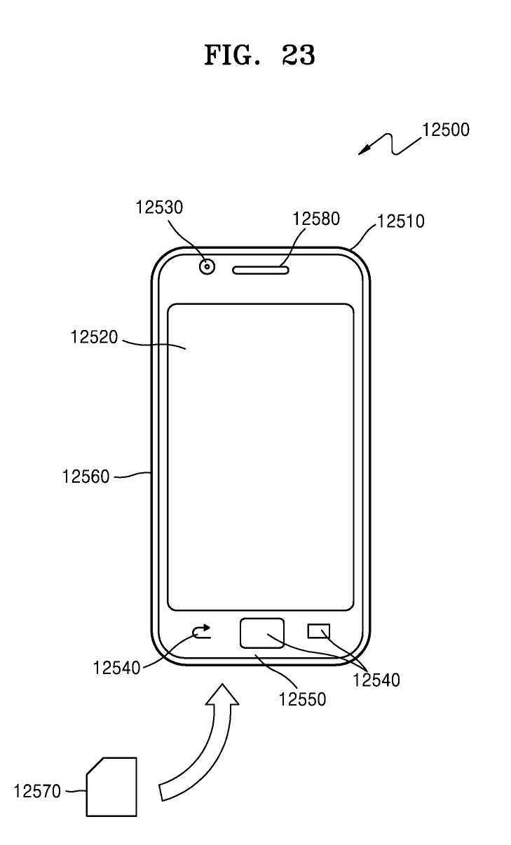

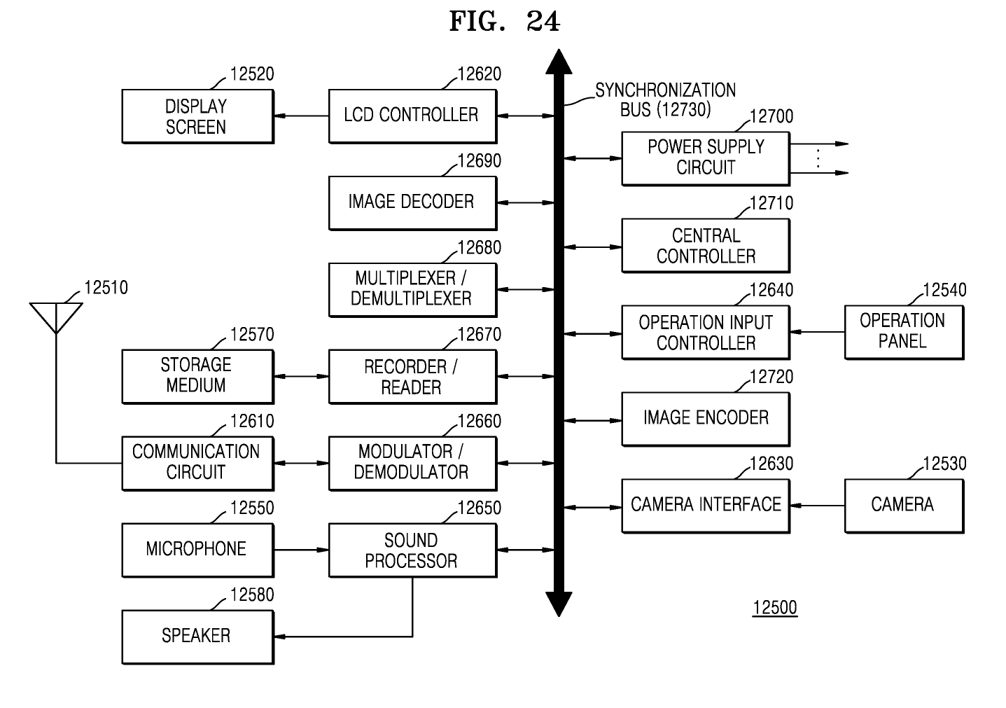

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 23 only illustrates the partition modes 912 through 918 which are obtained by symmetrically splitting the prediction unit 910, but a partition mode is not limited thereto, and the partitions of the prediction unit 910 may include asymmetrical partitions, partitions having a certain shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912 through 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1×N_1, a partition mode 946 having a size of N_1×2N_1, and a partition mode 948 having a size of N_1×N_1.

If an encoding error is the smallest in the partition mode 948, a depth is changed from 1 to 2 to split the partition mode 948 in operation 950, and encoding is repeatedly performed on coding units 960, which have a depth of 2 and a size of N_2×N_2 to search for a minimum encoding error.

When a maximum depth is d, split operation according to each depth may be performed up to when a depth becomes d−1, and splitting information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes 992 through 998 to search for a partition mode having a minimum encoding error.

Even when the partition mode 998 has the minimum encoding error, since a maximum depth is d, a coding unit CU_(d−1) having a depth of d−1 is no longer split to a lower depth, and a depth for the coding units constituting a current LCU 900 is determined to be d−1 and a partition mode of the current LCU 900 may be determined to be N_(d−1)×N_(d−1). Also, since the maximum depth is d and an SCU 980 having a lowermost depth of d−1 is no longer split to a lower depth, splitting information for the SCU 980 is not set.

A data unit 999 may be a ‘minimum unit’ for the current LCU. A minimum unit according to one or more embodiments may be a square data unit obtained by splitting an SCU 980 by 4. By performing the encoding repeatedly, the image encoding apparatus 100 may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 1 through d, and a depth having the least encoding error may be determined as a depth. The depth, the partition mode of the prediction unit, and the prediction mode may be encoded and transmitted as information about an encoding mode. Also, since a coding unit is split from a depth of 0 to a depth, only splitting information of the depth is set to 0, and splitting information of depths excluding the depth is set to 1.

The image data and encoding information extractor 220 of the image decoding apparatus 200 may extract and use the information about the depth and the prediction unit of the coding unit 900 to decode the partition 912. The image decoding apparatus 200 may determine a depth, in which splitting information is 0, as a depth by using splitting information according to depths, and use information about an encoding mode of the corresponding depth for decoding.

FIGS. 16, 17, and 18 are diagrams for describing a relationship between coding units 1010, prediction units 1060, and transformation units 1070, according to one or more embodiments.

The coding units 1010 are coding units having a tree structure, corresponding to depths determined by the image encoding apparatus 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition modes in the coding units 1014, 1022, 1050, and 1054 have a size of 2N×N, partition modes in the coding units 1016, 1048, and 1052 have a size of N×2N, and a partition mode of the coding unit 1032 has a size of N×N. Prediction units and partitions of the coding units 1010 are smaller than or equal to each coding unit.

Transformation or inverse-transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the image encoding and decoding apparatuses 100 and 200 may perform intra prediction, motion estimation, motion compensation, transformation, and inverse-transformation individually on a data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition mode, information about a prediction mode, and information about a size of a transformation unit. Table 1 shows the encoding information that may be set by the image encoding and decoding apparatuses 100 and 200.

TABLE 1

| Splitting information 0 | | | | | |
|---|---|---|---|---|---|
| (Encoding on Coding Unit having Size of 2N × 2N and Current Depth of d) | | | | | |
| | | | Size of Transformation Unit | | |
| | | | Splitting | Splitting | |
| | Partition mode | | information 0 | information 1 | |
| | Symmetrical | Asymmetrical | of | of | |
| Prediction | Partition | Partition | Transformation | Transformation | Splitting |
| Mode | mode | mode | Unit | Unit | information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding |
| (Only | N × N | nR × 2N | | N/2 × N/2 | Units |
| 2N × 2N) | | | | (Asymmetrical | having |
| | | | | Type) | Lower |
| | | | | | Depth of |
| | | | | | d + 1 |

The output unit 130 of the image encoding apparatus 100 may output the encoding information about the coding units having a tree structure, and the image data and encoding information extractor 220 of the image decoding apparatus 200 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a final depth, and thus information about a partition mode, prediction mode, and a size of a transformation unit may be defined for the final depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

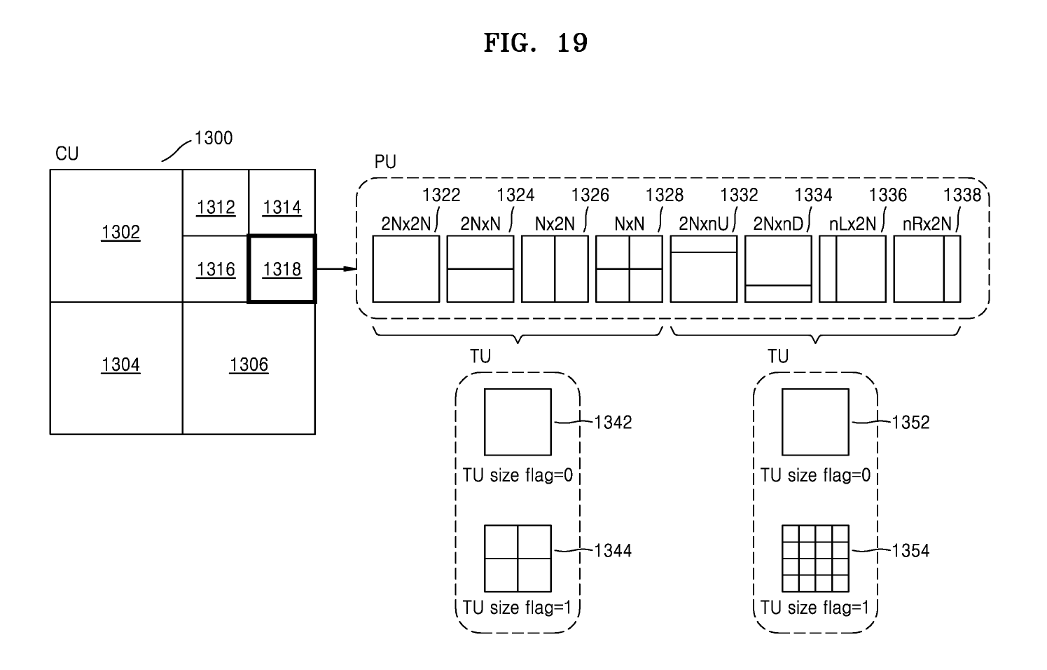

FIG. 19 is a diagram for describing a relationship between a coding unit, a prediction unit, and a transformation unit, according to encoding mode information of Table 1.

A LCU 1300 includes coding units 1302, 1304, 1306, 1312, 1314, 1316, and 1318 of depths. Here, since the coding unit 1318 is a coding unit of a depth, splitting information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Splitting information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

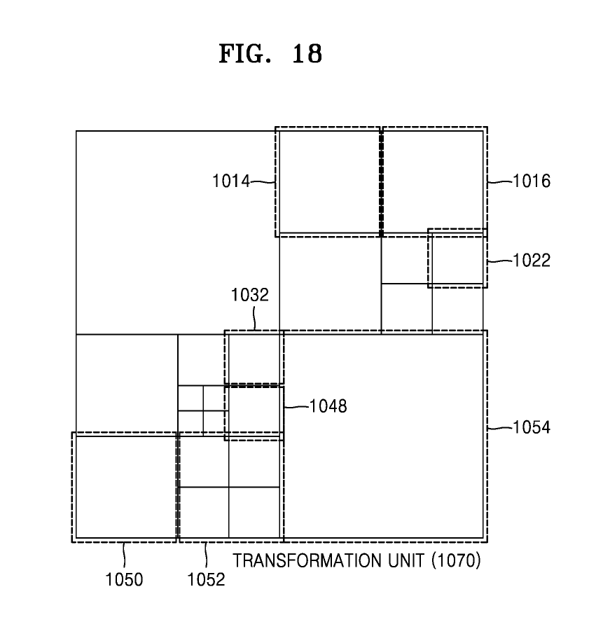

The TU size flag described above with reference to FIG. 18 is a flag having a value or 0 or 1, but the TU size flag is not limited to 1 bit, and a transformation unit may be hierarchically split having a tree structure while the TU size flag increases from 0. Splitting information (TU size flag) of a transformation unit may be an example of a transformation index.

In this case, the size of a transformation unit that has been actually used may be expressed by using a TU size flag of a transformation unit, according to one or more embodiments, together with a maximum size and minimum size of the transformation unit. The image encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The image decoding apparatus 200 may decode image by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to one or more embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the embodiments are not limited thereto.

According to the image encoding method based on coding units having a tree structure as described with reference to FIGS. 7 through 19, image data of the spatial domain is encoded for each coding unit of a tree structure. According to the image decoding method based on coding units having a tree structure, decoding is performed for each LCU to reconstruct image data of the spatial domain. Thus, a picture and an image that is a picture sequence may be reconstructed. The reconstructed image may be reproduced by a reproducing apparatus, stored in a storage medium, or transmitted through a network.

Also, offset parameters may be signalled to each picture, each slice, each LCU, each coding unit according to a tree structure, a prediction unit of a coding unit, or a transformation unit of a coding unit. For example, a LCU with the minimum error compared to an original block may be reconstructed by adjusting reconstructed pixel values of LCUs by using offset values reconstructed based on offset parameters received with respect to each LCU.

For convenience of description, the image encoding method described above with reference to FIGS. 1A through 18, will be referred to as an ‘image encoding method.’ In addition, the image decoding method described above with reference to FIGS. 1A through 18, will be referred to as an ‘image decoding method.’

An image encoding apparatus including the image encoding apparatus 10, the image encoding apparatus 100, or the image encoder 400, which is described above with reference to FIGS. 1A through 18, will be referred to as an ‘image encoding apparatus.’ In addition, an image decoding apparatus including the inter layer image decoding apparatus 20, the image decoding apparatus 200, or the image decoder 500, which is described above with reference to FIGS. 2A through 19, will be referred to as an ‘image decoding apparatus.’

A computer-readable recording medium storing a program, e.g., a disc 26000, according to one or more embodiments will now be described in detail.

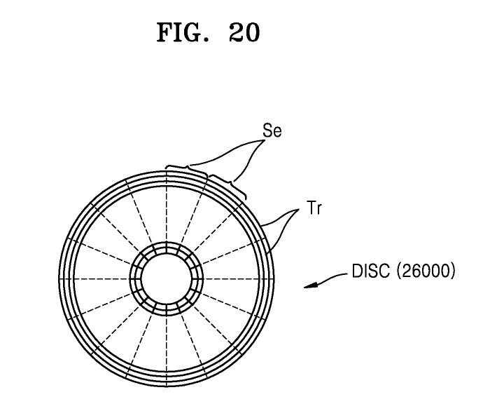

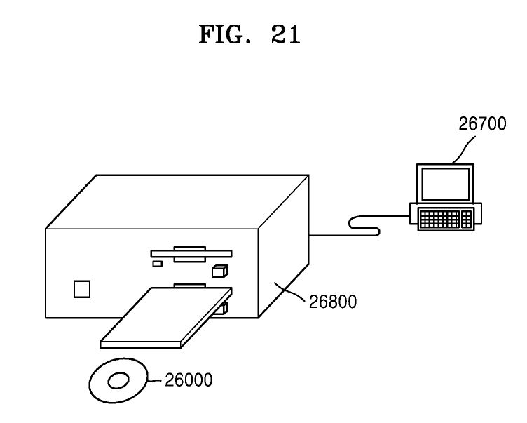

FIG. 20 is a diagram of a physical structure of the disc 26000 in which a program is stored, according to one or more embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the image encoding method, and the image decoding method described above may be assigned and stored.

A computer system embodied using a storage medium that stores a program for executing the image encoding method and the image decoding method as described above will now be described with reference to FIG. 21.

FIG. 21 is a diagram of a disc drive 26800 for recording and reading a program by using the disc 26000. A computer system 26700 may store a program that executes at least one of an image encoding method and an image decoding method according to one or more embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of an image encoding method and an image decoding method according to one or more embodiments may be stored not only in the disc 26000 illustrated in FIG. 20 or 21 but also in a memory card, a ROM cassette, or a solid state drive (SSD).

A system to which the image encoding method and an image decoding method described above are applied will be described below.

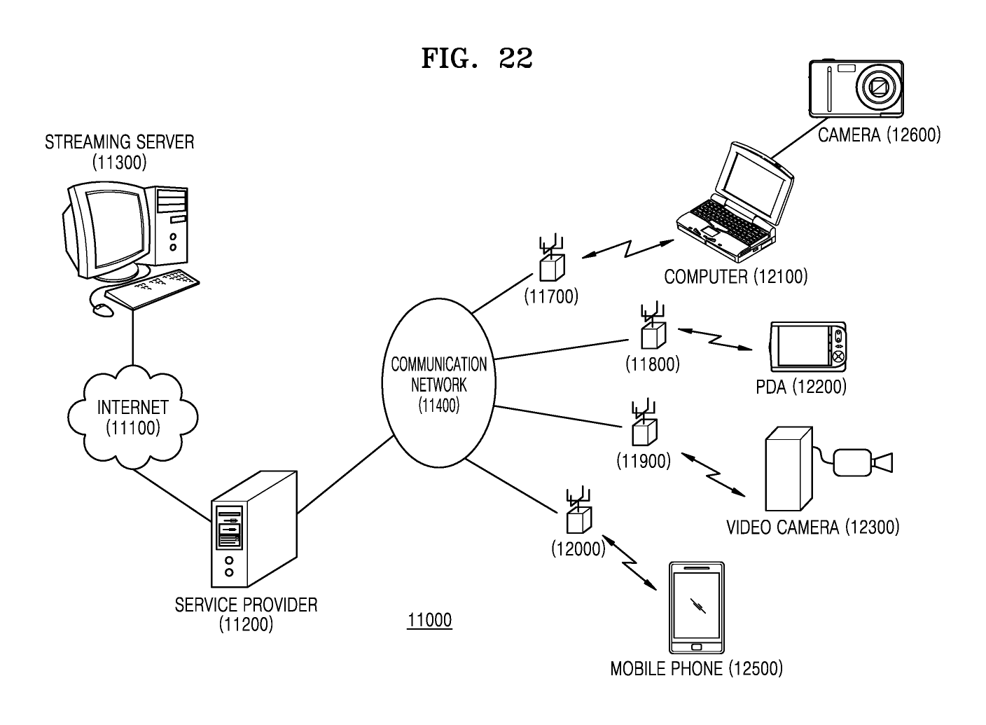

FIG. 22 is a diagram of an overall structure of a content supply system 11000 for providing a content distribution service. A service area of a communication system is divided into certain-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, an image camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 22, and devices may be selectively connected thereto. The plurality of independent devices may be directly connected to the communication network 11400, not via the wireless base stations 11700, 11800, 11900, and 12000.

The image camera 12300 is an imaging device, e.g., a digital image camera, which is capable of capturing image images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The image camera 12300 may be connected to a streaming server 11300 via the wireless base station 11900 and the communication network 11400. The streaming server 11300 allows content received from a user via the image camera 12300 to be streamed via a real-time broadcast. The content received from the image camera 12300 may be encoded using the image camera 12300 or the streaming server 11300. Image data captured by the image camera 12300 may be transmitted to the streaming server 11300 via the computer 12100.

Image data captured by a camera 12600 may also be transmitted to the streaming server 11300 via the computer 12100. The camera 12600 is an imaging device capable of capturing both still images and image images, similar to a digital camera. The image data captured by the camera 12600 may be encoded using the camera 12600 or the computer 12100. Software that performs encoding and decoding image may be stored in a computer-readable recording medium, e.g., a CD-ROM disc, a floppy disc, a hard disc drive, an SSD, or a memory card, which may be accessible by the computer 12100.

If image data is captured by a camera built in the mobile phone 12500, the image data may be received from the mobile phone 12500.

The image data may also be encoded by a large scale integrated circuit (LSI) system installed in the image camera 12300, the mobile phone 12500, or the camera 12600.

The content supply system 11000 may encode content data recorded by a user using the image camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the image camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of an image encoding apparatus and an image decoding apparatus according to one or more embodiments.

The mobile phone 12500 included in the content supply system 11000 according to one or more embodiments will now be described in greater detail with referring to FIGS. 23 and 24.

FIG. 23 illustrates an external structure of the mobile phone 12500 to which an image encoding method and an image decoding method are applied, according to one or more embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound inputter. The mobile phone 12500 further includes the camera 12530, such as a charge-coupled device (CCD) camera, to capture image and still images. The mobile phone 12500 may further include a storage medium 12570 for storing encoded/decoded data, e.g., image or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 24 illustrates an internal structure of the mobile phone 12500, according to one or more embodiments. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described image encoding method according to the one or more embodiments. The image encoder 12720 may transform the image data received from the camera 12530 into compressed and encoded image data based on the above-described image encoding method according to the one or more embodiments, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the image decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of an image file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded image data stream and an encoded audio data stream. Via the synchronization bus 12730, the encoded image data stream and the encoded audio data stream are provided to the image decoding unit 12690 and the sound processor 12650, respectively.

A structure of the image decoder 12690 may correspond to that of the above-described image decoding method according to the one or more embodiments. The image decoder 12690 may decode the encoded image data to obtain reconstructed image data and provide the reconstructed image data to the display screen 12520 via the LCD controller 12620, by using the above-described image decoding method according to the one or more embodiments.

Thus, the data of the image file accessed at the Internet website may be displayed on the display screen 12520. At the same time, the sound processor 12650 may transform audio data into an analog sound signal, and provide the analog sound signal to the speaker 12580. Thus, audio data contained in the image file accessed at the Internet website may also be reproduced via the speaker 12580.

The mobile phone 12500 or another type of communication terminal may be a transceiving terminal including both an image encoding apparatus and an image decoding apparatus according to one or more embodiments, may be a transceiving terminal including only the image encoding apparatus, or may be a transceiving terminal including only the image decoding apparatus.

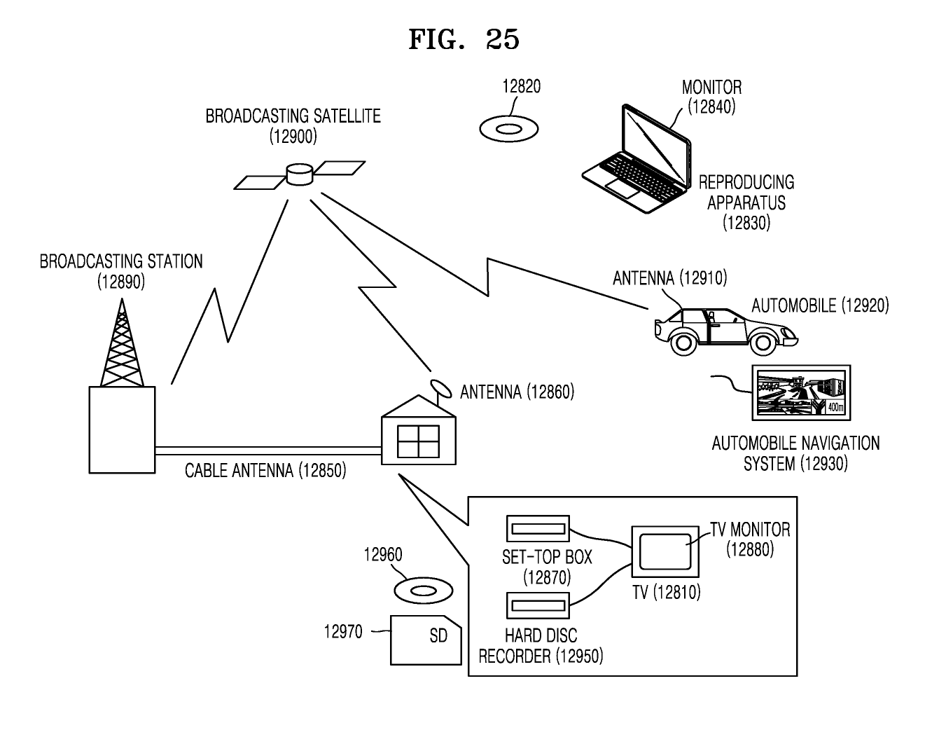

A communication system according to the one or more embodiments is not limited to the communication system described above with reference to FIG. 23. For example, FIG. 25 illustrates a digital broadcasting system employing a communication system, according to one or more embodiments. The digital broadcasting system of FIG. 25 may receive a digital broadcast transmitted via a satellite or a terrestrial network by using an image encoding apparatus and an image decoding apparatus according to one or more embodiments.

Specifically, a broadcasting station 12890 transmits an image data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded image stream may be decoded and reproduced by a TV receiver 12810, a set-top box 12870, or another device.

When an image decoding apparatus according to one or more embodiments is implemented in a reproducing apparatus 12830, the reproducing apparatus 12830 may parse and decode an encoded image stream recorded on a storage medium 12820, such as a disc or a memory card to reconstruct digital signals. Thus, the reconstructed image signal may be reproduced, for example, on a monitor 12840.

In the set-top box 12870 connected to the antenna 12860 for a satellite/terrestrial broadcast or a cable antenna 12850 for receiving a cable television (TV) broadcast, an image decoding apparatus according to one or more embodiments may be installed. Data output from the set-top box 12870 may also be reproduced on a TV monitor 12880.

As another example, an image decoding apparatus according to one or more embodiments may be installed in the TV receiver 12810 instead of the set-top box 12870.

An automobile 12920 that has an appropriate antenna 12910 may receive a signal transmitted from the satellite 12900 or the wireless base station 11700 of FIG. 21. A decoded image may be reproduced on a display screen of an automobile navigation system 12930 installed in the automobile 12920.

A image signal may be encoded by an image encoding apparatus according to one or more embodiments and may then be stored in a storage medium. Specifically, an image signal may be stored in a DVD disc 12960 by a DVD recorder or may be stored in a hard disc by a hard disc recorder 12950. As another example, the image signal may be stored in an SD card 12970. If the hard disc recorder 12950 includes an image decoding apparatus according to one or more embodiments, an image signal recorded on the DVD disc 12960, the SD card 12970, or another storage medium may be reproduced on the TV monitor 12880.

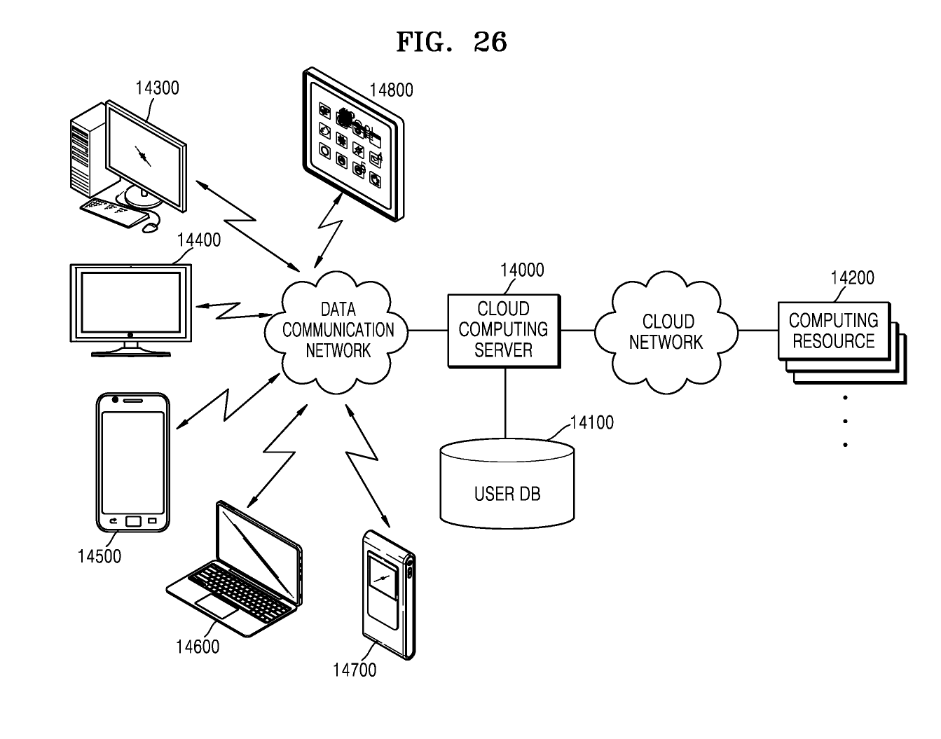

The automobile navigation system 12930 may not include the camera 12530 of FIG. 26, and the camera interface 12630 and the image encoder 12720 of FIG. 26. For example, the computer 12100 and the TV receiver 12810 may not include the camera 12530, the camera interface 12630, and the image encoder 12720.

FIG. 26 is a diagram illustrating a network structure of a cloud computing system using an image encoding apparatus and an image decoding apparatus, according to one or more embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly image reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining image database distributed in different regions according to the virtualization technology.

User information about users who have subscribed for a cloud computing service is stored in the user DB 14100. The user information may include logging information, addresses, names, and personal credit information of the users. The user information may further include indexes of images. Here, the indexes may include a list of images that have already been reproduced, a list of images that are being reproduced, a pausing point of an image that was being reproduced, and the like.

Information about an image stored in the user DB 14100 may be shared between user devices. For example, when an image service is provided to the notebook computer 14600 in response to a request from the notebook computer 14600, a reproduction history of the image service is stored in the user DB 14100. When a request to reproduce this image service is received from the smart phone 14500, the cloud computing server 14000 searches for and reproduces this image service, based on the user DB 14100. When the smart phone 14500 receives an image data stream from the cloud computing server 14000, a process of reproducing image by decoding the image data stream is similar to an operation of the mobile phone 12500 described above with reference to FIG. 23.

The cloud computing server 14000 may refer to a reproduction history of a desired image service, stored in the user DB 14100. For example, the cloud computing server 14000 receives a request to reproduce an image stored in the user DB 14100, from a user terminal. If this image was being reproduced, then a method of streaming this image, performed by the cloud computing server 14000, may vary according to the request from the user terminal, i.e., according to whether the image will be reproduced, starting from a start thereof or a pausing point thereof. For example, if the user terminal requests to reproduce the image, starting from the start thereof, the cloud computing server 14000 transmits streaming data of the image starting from a first frame thereof to the user terminal. If the user terminal requests to reproduce the image, starting from the pausing point thereof, the cloud computing server 14000 transmits streaming data of the image starting from a frame corresponding to the pausing point, to the user terminal.

In this case, the user terminal may include an image decoding apparatus as described above with reference to FIGS. 1A through 19. As another example, the user terminal may include an image encoding apparatus as described above with reference to FIGS. 1A through 19. Alternatively, the user terminal may include both the image decoding apparatus and the image encoding apparatus as described above with reference to FIGS. 1A through 19.

Various applications of an image encoding method, an image decoding method, an image encoding apparatus, and an image decoding apparatus according to the one or more embodiments described above with reference to FIGS. 1A through 26 have been described above with reference to FIGS. 13 to 19. However, methods of storing the image encoding method and the image decoding method in a storage medium or methods of implementing the image encoding apparatus and the image decoding apparatus in a device, according to one or more embodiments, described above with reference to FIGS. 1A through 19 are not limited to the embodiments described above with reference to FIGS. 20 to 26.

As used herein, the expression “A may include one of a1, a2, and a3” means that the component A may broadly include exemplary elements a1, a2, or a3.

The above expression does not necessarily limit the elements that may constitute the component A to a1, a2, or a3. Thus, the expression does not exclusively mean that an element that may be included in the component A excludes elements that are not exemplified, other than the elements a1, a2, and a3.

Further, the above expression means that the component A may include the element a1, a2, or a3. The expression does not necessarily mean that the elements included in the component A are selectively determined from a certain group. For example, the expression does not limitedly mean that the element a1, a2, or a3 selected from a group including a1, a2, and a3 is necessarily included in the component A.

In addition, in the inventive concept, the expression “at least one of a1, a2, or (and) a3” means one of “a1”, “a2”, “a3”, “a1 and a2”, “a1 and a3”, “a2 and a3”, and “a1, a2 and a3.”

Thus, unless explicitly described as “at least one of a1, at least one of a2, or (and) at least one of a3”, the expression “at least one of a1, a2, or (and) a3” does not mean “at least one of a1, at least one of a2, or (and) at least one of a3.”

The embodiments may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

While one or more embodiments have been described with reference to the figures, it will be understood by those of ordinary skill in the art that various changes in form and details may be made therein without departing from the spirit and scope as defined by the following claims.

What is claimed is:

1. A method of encoding an image, the method comprising:
processing, by at least one hardware processor included in an image encoding apparatus, information stored in at least one memory included in the image encoding apparatus, to thereby cause the image encoding apparatus to perform:
determining a scanning sequence for transforming one or more sub-blocks included in a transformation block of the image to be identical to a sequence of quantizing the one or more sub-blocks;
determining a sub-block for transformation from among the one or more sub-blocks according to the determined scanning sequence; and
performing transformation by applying one or more transformation matrixes with respect to the determined sub-block for transformation.

2. The method of claim 1, wherein the determined scanning sequence is a reverse scanning sequence and comprises a horizontal scanning sequence, a vertical scanning sequence, and an upright diagonal scanning sequence.

3. The method of claim 2, wherein the one or more transformation matrixes comprise a first transformation matrix and a second transformation matrix that is a transposed matrix of the first transformation matrix.

4. The method of claim 3, wherein, when the determined scanning sequence is the horizontal scanning sequence, the first transformation matrix is first applied with respect to the determined sub-block for transformation, and,
when the determined scanning sequence is the vertical scanning sequence or the upright diagonal scanning sequence, the second transformation matrix is first applied with respect to the determined sub-block for transformation.

5. The method of claim 1, wherein the performing of the transformation comprises performing transformation by using a pixel processing unit same as a processing unit for quantization and rate-distortion cost calculation that are performed in form of a pipeline after the transformation.

6. The method of claim 1, wherein a size of the one or more sub-blocks is 4×4 pixels, and
a size of the transformation block is equal to or greater than 4×4 pixels.

7. A method of decoding an image, the method comprising:
processing, by at least one hardware processor included in an image decoding apparatus, information stored in at least one memory included in the image decoding apparatus, to thereby cause the image decoding apparatus to perform:
determining a scanning sequence for inverse-transforming one or more sub-blocks included in an inverse-transformation block of the image to be identical to a sequence of inverse-quantizing the one or more sub-blocks;
determining a sub-block for inverse-transformation from among the one or more sub-blocks according to the determined scanning sequence; and
performing inverse-transformation by applying one or more inverse-transformation matrixes with respect to the determined sub-block for inverse-transformation.

8. The method of claim 7, wherein the determined scanning sequence is a reverse scanning sequence and comprises a horizontal scanning sequence, a vertical scanning sequence, and an upright diagonal scanning sequence.

9. The method of claim 8, wherein the one or more inverse-transformation matrixes comprise a first inverse-transformation matrix and a second inverse-transformation matrix that is a transposed matrix of the first inverse-transformation matrix.

10. The method of claim 9, wherein, when the determined scanning sequence is the horizontal scanning sequence, the first inverse-transformation matrix is first applied with respect to the determined sub-block for inverse-transformation, and,
when the determined scanning sequence is the vertical scanning sequence or the upright diagonal scanning sequence, the second inverse-transformation matrix is first applied with respect to the determined sub-block for inverse-transformation.

11. The method of claim 7, wherein the performing of the inverse-transformation comprises performing inverse-transformation by using a pixel processing unit identical to a processing unit for quantization that is performed in form of a pipeline before the inverse-transformation.

12. The method of claim 7, wherein a size of the one or more sub-blocks is 4×4 pixels, and
a size of the inverse-transformation block is equal to or greater than 4×4 pixels.

13. An image decoding apparatus comprising:
at least one hardware processor that processes information stored in at least one memory to implement:
an inverse transformation sequence determiner configured to determine a scanning sequence for inverse-transforming one or more sub-blocks included in an inverse-transformation block of the image to be identical to a sequence of inverse-quantizing the one or more sub-blocks and determine a sub-block for inverse-transformation from among the one or more sub-blocks according to the determined scanning sequence; and
an inverse transforming unit configured to perform inverse-transformation by applying one or more inverse-transformation matrixes with respect to the determined sub-block for inverse-transformation.
